(19) United States
(12) Patent Application Publication
(10) Pub. No.: US 2024/0383381 A1
(43) Pub. Date: Nov. 21, 2024

(54) STOWABLE CHILD RESTRAINT SYSTEM FOR A VEHICLE SEAT

(71) Applicant: Indiana Mills & Manufacturing, Inc., Westfield, IN (US)

(72) Inventors: Steven Gale, Colfax, IN (US); Jeffrey Alan King, Markleville, IN (US); John Gordon Glover, Danville, IN (US); Douglas Wayne Bittner, Indianapolis, IN (US)

(73) Assignee: Indiana Mills & Manufacturing, Inc., Westfield, IN (US)

(21) Appl. No.: 18/786,847

(22) Filed: Jul. 29, 2024

Related U.S. Application Data
(63) Continuation of application No. PCT/US2023/062039, filed on Feb. 6, 2023.
(60) Provisional application No. 63/267,614, filed on Feb. 7, 2022.

(51) Int. Cl. B60N 2/26; B60N 2/28

(52) U.S. Cl. CPC B60N 2/267; B60N 2/271; B60N 2/2803

(57) ABSTRACT

A vehicle safety system includes a vehicle seat and a child restraint system integrated with the vehicle seat. The child restraint system includes an illuminated status indicator system. The child restraint system includes an occupant detection system. The child restraint system includes one or more position sensors configured to determine seat bottom position. The child restraint includes a harness system. The harness system is stored behind a door panel in a seat back of the vehicle seat. The harness system includes one or more load sensors. The load sensors work in combination with a motor to automatically adjust harness fit. The child restraint system is configured to automatically deploy. The child restraint system is configured to automatically stow. The vehicle safety system includes an input/output (I/O) device configured to facilitate interactions with the child restraint system.

### CROSS REFERENCE TO RELATED APPLICATIONS

This application is a continuation of International Patent Application Number PCT/US2023/062039, filed Feb. 6, 2023, which is hereby incorporated by reference. International Patent Application Number PCT/US2023/062039, filed Feb. 6, 2023, claims the benefit of U.S. Patent Application No. 63/267,614, filed Feb. 7, 2022, which are hereby incorporated by reference.

### BACKGROUND

Child safety seats are commonly used to secure and protect children in a variety of vehicles. Various harness configurations, such as with three-point or five-point harnesses, can be used to safely and comfortably secure the child. Buckles are typically used to join together the various webs or belts forming the harness so as to secure the occupant. The buckle must remain locked and must be configured to withstand significant forces that occur during an accident, and at the same time, the buckle needs to be able to be repeatedly locked and unlocked to facilitate removal of the occupant from the harness. At times, it can also be difficult to determine whether the belts are properly tensioned and buckled. This includes difficulty discerning whether the belts are too loose or too tight. To accommodate different vehicle configurations and/or children of variable sizes, belts may be designed with excess length to provide adjustability. When the child is secured to the seat, the belts may be adjusted to a shorter effective length for a relatively snug fit. The tension of the belts must be sufficient to safely secure the child, but the tension of the belts should not be too tight to as to be uncomfortable. While Isofix anchor systems have been developed to make installation and removal of car safety seats and booster seats somewhat easier, the process is still inconvenient.

Thus, there is a need for improvement in this field.

### SUMMARY

A stowable child restraint or harness system has been developed to simplify the process of securing a child to a standard vehicle seat such as those commonly found in passenger vehicles. Instead of using a separate child safety seat that is supplied as an aftermarket product by an outside equipment manufacturer (OEM), the child restraint system is integrated into the seat by the vehicle manufacturer. The restraint system is configured to be conveniently stowed when an adult sits in the seat, and at the same time, the restraint system is able to be readily deployed and adjusted to accommodate children of various ages, sizes, and body types. The restraint system is further configured to guide a child care giver during the entire process of securing and removing the child from the restraint system. The restraint also aids in securing the child, including automatically tightening the restraints on the child to the proper tightness so that the child is secure but not uncomfortable. Moreover, the restraint system is configured to alert the caregiver if the child is not properly secured. For instance, the system is designed to provide alerts about whether the belts are properly secured to the buckle and/or properly tensioned.

A unique system and method for manually preparing a stowable child seat and securing a passenger has been developed. The stowable child restraint system also includes a system and method for automatically preparing a child safety seat, including by transitioning an adult seat into a child seat. The automated seat includes features that will automatically remove or add tension to the safety belts until a proper tension is achieved, safely securing the child. The system also includes communication devices such as lights, sounds, and display in order to communicate the status of a passenger in the child safety seat as well as the status child safety seat, including whether the seatbelt is properly fastened. The automated aspects of this design are particularly helpful for securing passengers which are not capable of securing themselves and/or are not capable of communicating their needs.

The terms adult and child are used herein to help differentiate the needs of two separate passengers. However, the two passengers need not necessarily be an adult or a child. For instance, individuals with special needs or with handicaps may benefit from the assistance of the system disclosed herein, including by receiving assistance with tightening or loosening the safety belt properly and at the appropriate time. The system and apparatus developed assists individuals who have communication issues by providing alerts to another user as to the status of the seat and the passenger in the seat. The automated aspects of this design are particularly helpful for securing passengers who are not capable of securing themselves and/or are not capable of communicating their needs.

In certain embodiments, the entirety of the process is automated and in others the entire system is manually operated. In still further embodiments, the. These various aspects of the transformable car seat and system are particularly helpful for manufacturing seats to fit a specific need. For instance, certain passengers, including paraplegic adults, do not require a booster seat configuration to raise in order to sit comfortably but would benefit from a feature which automatically places and/or tightens the straps of the safety belt in a vehicle.

A novel methodology of altering a car seat to facilitate securing a child in the seat has been developed. The method includes multiple aspects and/or sequences for optimizing the preparation of a vehicle car seat and securing of a passenger. The methods discussed herein guide the user in a series of steps that are designed to provide efficiency, safety, and comfort pertaining to securing a passenger. In one such method, the seatback is opened or folded down to reveal child seat restraints not utilized by typical adult passengers. In some examples, the headrest of the seat is lifted to free slack to run in the system to secure the passenger. The methodology disclosed herein also includes the integration of sensor devices and as well as communication devices such as a display that inform the user about the seat and the passenger. The methods discussed herein also provide sequential logical inquiries to be utilized by a controller during the implementation of the restraint system in order to help facilitate proper and efficient use of the system.

The system and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a vehicle safety system.

Aspect 3 generally concerns the system of any previous aspect including a vehicle seat.

Aspect 4 generally concerns the system of any previous aspect including a child restraint system integrated with the vehicle seat.

Aspect 5 generally concerns the system of any previous aspect in which the child restraint system includes an illuminated status indicator system.

Aspect 6 generally concerns the system of any previous aspect in which the child restraint system includes an occupant detection system.

Aspect 7 generally concerns the system of any previous aspect in which the child restraint system includes one or more position sensors configured to determine seat bottom position.

Aspect 8 generally concerns the system of any previous aspect in which the child restraint includes a harness system.

Aspect 9 generally concerns the system of any previous aspect in which the harness system is stored behind a door panel in a seat back of the vehicle seat.

Aspect 10 generally concerns the system of any previous aspect in which the harness system includes one or more load sensors.

Aspect 11 generally concerns the system of any previous aspect in which the load sensors work in combination with a motor to automatically adjust harness fit.

Aspect 12 generally concerns the system of any previous aspect in which the child restraint system is configured to automatically deploy.

Aspect 13 generally concerns the system of any previous aspect in which the child restraint system is configured to automatically stow.

Aspect 14 generally concerns the system of any previous aspect including an input/output (I/O) device configured to facilitate interactions with the child restraint system.

Aspect 15 generally concerns the system of any previous aspect in which the adult restraint system integrated with the vehicle seat.

Aspect 16 generally concerns the system of any previous aspect in which the vehicle seat includes a seat bottom and a seat back.

Aspect 17 generally concerns the system of any previous aspect in which the seat back includes a door panel configured to move.

Aspect 18 generally concerns the system of any previous aspect in which the door panel includes a set of bomb bay doors.

Aspect 19 generally concerns the system of any previous aspect in which the door panel includes a drawbridge type door.

Aspect 20 generally concerns the system of any previous aspect in which the seat bottom is movable from a first position to a second position.

Aspect 21 generally concerns the system of any previous aspect in which the first position is a seating position.

Aspect 22 generally concerns the system of any previous aspect in which the second position is a booster seat position.

Aspect 23 generally concerns the system of any previous aspect in which the passenger vehicle including the vehicle seat.

Aspect 24 generally concerns a method.

Aspect 25 generally concerns a system or method.

Aspect 26 generally concerns a method of operating the system.

Aspect 27 generally concerns the system or method of any previous aspect including deploying the booster seat from a stowed position to a boosted position.

Aspect 28 generally concerns the system or method of any previous aspect including opening one or more door panels in a seat back to reveal at least part of the harness.

Aspect 29 generally concerns the system or method of any previous aspect in which the door panels include a drawbridge type panel.

Aspect 30 generally concerns the system or method of any previous aspect including deploying the booster seat includes folding the drawbridge type panel away from the seat back to form the booster seat.

Aspect 31 generally concerns the system or method of any previous aspect in which the door panels have a bomb bay door type configuration.

Aspect 32 generally concerns the system or method of any previous aspect including detecting state of the doors with one or more door sensors.

Aspect 33 generally concerns the system or method of any previous aspect in which the deploying the booster seat includes actuating a release lever on the booster seat to release the booster seat.

Aspect 34 generally concerns the system or method of any previous aspect in which the deploying the booster seat includes exposing a foot rest when in the boosted position.

Aspect 35 generally concerns the system or method of any previous aspect including loosening a harness.

Aspect 36 generally concerns the system or method of any previous aspect including actuating a headrest lever located on a headrest to allow slackening of the harness.

Aspect 37 generally concerns the system or method of any previous aspect including raising the headrest while actuating the headrest lever.

Aspect 38 generally concerns the system or method of any previous aspect in which the harness includes one or more belts.

Aspect 39 generally concerns the system or method of any previous aspect in which the harness includes a buckle.

Aspect 40 generally concerns the system or method of any previous aspect including loosening the harness includes pulling the belts of the harness from the seat back.

Aspect 41 generally concerns the system or method of any previous aspect including buckling an occupant into the harness of the booster seat when in the boosted position by latching the buckle.

Aspect 42 generally concerns the system or method of any previous aspect including tightening the harness around the occupant.

Aspect 43 generally concerns the system or method of any previous aspect including unlatching the buckle to release the occupant from the harness.

Aspect 44 generally concerns the system or method of any previous aspect including detecting the unlatching of the buckle with the controller via the buckle sensor.

Aspect 45 generally concerns the system or method of any previous aspect including stowing the booster seat by moving the booster from the boosted position to the stowed position.

Aspect 46 generally concerns the system or method of any previous aspect including detecting the booster seat is in the stowed position with the controller via the booster seat sensor.

Aspect 47 generally concerns the system or method of any previous aspect including retracting the belts of the harness with the motor in response to the detecting the unlatching of the buckle and the detecting the booster seat is in the stowed position.

Aspect 48 generally concerns the system or method of any previous aspect including stowing the booster seat includes folding the booster seat into the seatback.

Aspect 49 generally concerns the system or method of any previous aspect including storing the harness.

Aspect 50 generally concerns the system or method of any previous aspect in which the storing includes stowing the belts of the harness behind the door panels.

Aspect 51 generally concerns the system or method of any previous aspect including providing an indicator that an occupant is secured in a proper manner in the harness.

Aspect 52 generally concerns the system or method of any previous aspect in which the indicator includes one or more indicator lights.

Aspect 53 generally concerns the system or method of any previous aspect including detecting the booster seat at the boosted position with a controller via a booster seat sensor.

Aspect 54 generally concerns the system or method of any previous aspect including loosening one or more belts of a harness in response to the detecting the booster seat at the boosted position.

Aspect 55 generally concerns the system or method of any previous aspect in which the loosening includes activating a motor with the controller to relieve tension from the belts.

Aspect 56 generally concerns the system or method of any previous aspect including detecting buckling of the buckle of the harness with the controller via a buckle sensor.

Aspect 57 generally concerns the system or method of any previous aspect including tightening the belts of the harness.

Aspect 58 generally concerns the system or method of any previous aspect including tightening the belts of the harness until proper tension is reached.

Aspect 59 generally concerns the system or method of any previous aspect in which the tightening occurs in response to the detecting the buckling of the buckle.

Aspect 60 generally concerns the system or method of any previous aspect including delaying the tightening for a delay period after the detecting of the buckling of the buckle.

Aspect 61 generally concerns the system or method of any previous aspect in which the delay period is at least 2 seconds.

Aspect 62 generally concerns the system or method of any previous aspect including sensing tension of the belts with a belt tension sensor.

Aspect 63 generally concerns the system or method of any previous aspect including applying tension to the belts until at least a belt tension limit is sensed with the belt tension sensor.

Aspect 64 generally concerns the system or method of any previous aspect in which the tightening includes activating a motor with the controller to apply tension to the belts.

Aspect 65 generally concerns the system or method of any previous aspect including calibrating the controller by latching and unlatching the buckle.

Aspect 66 generally concerns the system or method of any previous aspect including switching between an automatic tensioning mode and a manual tensioning mode of the harness when a switch is actuated.

Aspect 67 generally concerns the system or method of any previous aspect including changing to the automatic tensioning mode by unlatching the buckle.

Aspect 68 generally concerns the system or method of any previous aspect including detecting occupancy of the booster seat with an occupancy sensor in the booster seat.

Aspect 69 generally concerns the system or method of any previous aspect in which the booster seat is integrated into an adult seat of a vehicle.

Aspect 70 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of an integrated restraint system according one example.

FIG. 2 is a perspective view of a child seat according to one example.

FIG. 3 is a cross-sectional view of the FIG. 2 child seat

FIG. 4 is a perspective view of a seatback compartment according to one example.

FIG. 5 is a partial cross-sectional view of FIG. 3 child seat.

FIG. 6 is a partial cross-sectional view of the seat bottom compartment of the child seat.

FIG. 7 is a partial cross-sectional view of an internal release mechanism according to one example.

FIG. 8 is a partial cross-sectional view of a tightening mechanism according to one example.

FIG. 9 is a block diagram of a stage according to one example.

FIG. 10 is a block diagram of the stage according to another example.

FIG. 11 is a block diagram of the seat assembly depicting location of the restraint tightening mechanism.

FIG. 12 is a block diagram of the integrated restraint system according to one example.

FIG. 13 is a perspective view of a display system according to one example.

FIG. 14 is a perspective view of an adult buckle according to one example.

FIG. 15 is a partial cross-sectional view of the seat bottom compartment of FIG. 13 child seat.

FIG. 16 is a partial cross-sectional view of the child seat back of FIG. 13.

FIG. 17 is a block diagram of the stage according to one example.

FIG. 18 is a block diagram of the stage according to another example.

FIG. 19 is a flowchart of a flowchart.

FIG. 20 is a flowchart of a flowchart.

FIG. 21 is a rear perspective view of the child seat headrest including a headrest handle release.

FIG. 22 is a perspective view of the seatback door panel of FIG. 13.

FIG. 23 is a perspective view of the recessed child restraint of FIG. 13.

FIG. 24 is a perspective view of the child seat booster of FIG. 13.

FIG. 25 is a perspective view of the child restraint of the integrated restraint system with passenger according to one example.

FIG. 26 is a side perspective view of the child restraint of the integrated restraint system with passenger according to one example.

FIG. 27 is a perspective view of the buckle of the integrated restraint system.

FIG. 28 is a perspective view of the seatback door panel.

FIG. 29 is a perspective view of the headrest handle release.

FIG. 30 is a perspective view of a winged door panel according to one example.

FIG. 31 is a perspective view of the child seat booster of FIG. 13.

FIG. 32 is a perspective view of the child restraint of FIG. 13.

FIG. 33 is a perspective view of the child seat back of the FIG. 13.

FIG. 34 is a perspective view of the buckle of FIG. 13.

FIG. 35 is a perspective view of the child restraint of the integrated restraint system with passenger according to one example.

FIG. 36 is a perspective view of the controller the according to one example.

FIG. 37 is a perspective view of the buckle of the integrated restraint system.

FIG. 38 is a perspective view of the adult seatback of the integrated restraint system.

FIG. 39 is a perspective view of a five point harness according to one example.

FIG. 40 is a side perspective view of a 40 according to one example.

FIG. 41 is a perspective view of the 190 of the integrated restraint system.

FIG. 42 is a perspective view of a retraction motor according to one example.

FIG. 43 is a perspective view of an occupant detection sensor according to one example.

FIG. 44 is a perspective view of the controller according to one example.

FIG. 45 is a perspective view of the child seat booster of the integrated restraint system.

FIG. 46 is a perspective view of the seatback door panel of the integrated restraint system.

FIG. 47 is a perspective view of the controller according to one example.

FIG. 48 is a perspective view of the buckle according to one example.

FIG. 49 is a perspective view of a tongue according to one example.

FIG. 50 is a perspective view of a tongue stop according to one example.

FIG. 51 is a perspective view of a Y-belt according to one example.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

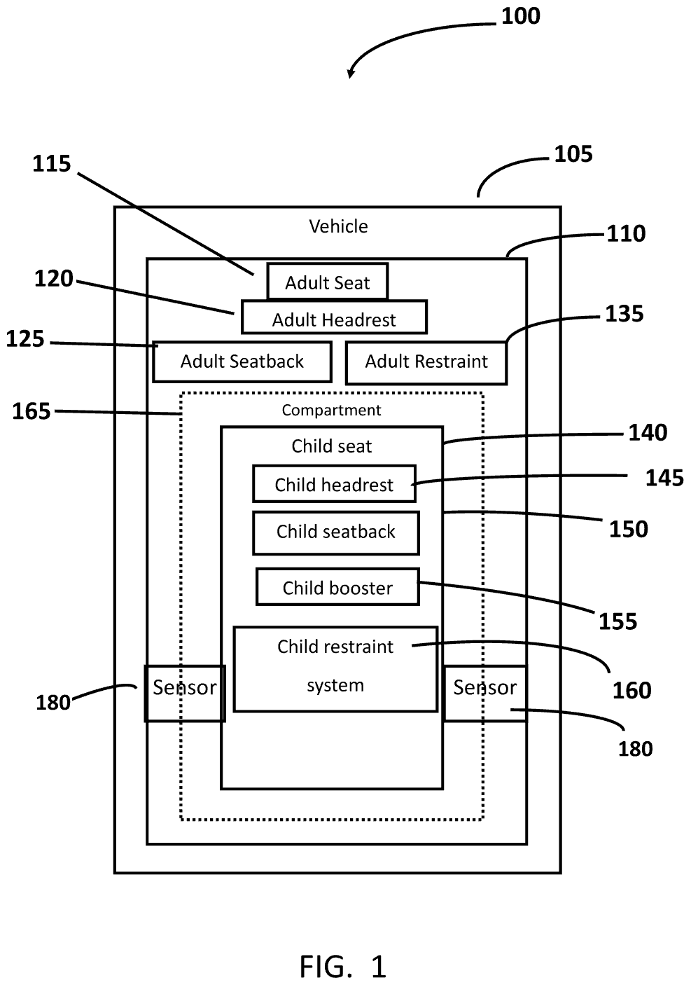

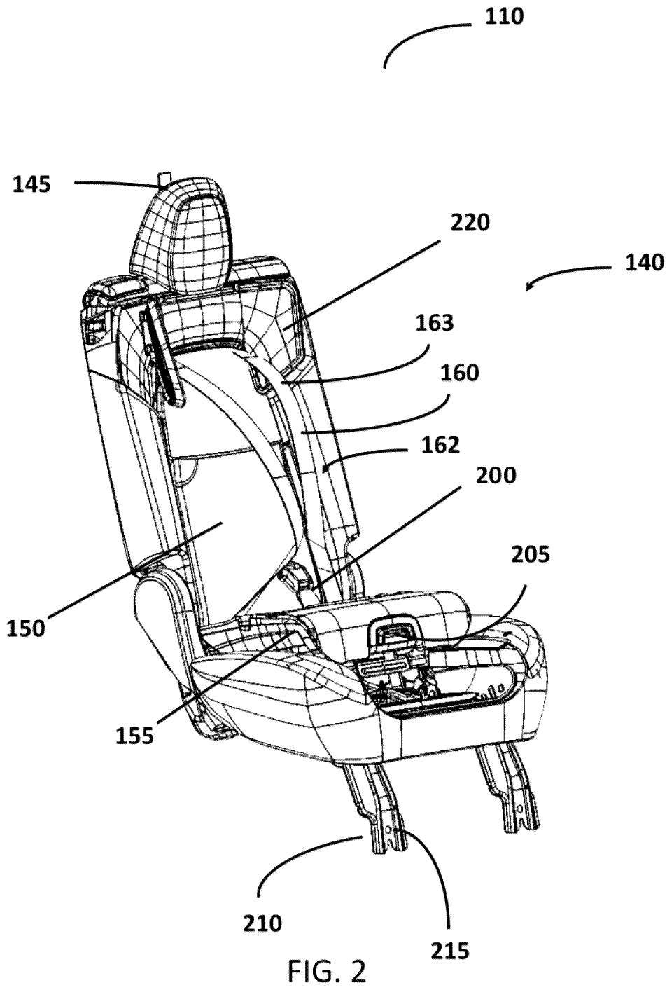

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a diagram of an integrated restraint system 100. The integrated restraint system 100 is positioned within a vehicle 105. The integrated restraint system 100 has a seat assembly 110 housed within the vehicle 105. The seat assembly 110 includes a child and adult configuration adaptable to the needs of the passenger by transitioning between multiple forms. One form of the seat assembly 110 is an adult seat 115. The adult seat 115 has an adult seat headrest 120 connected to an adult seatback 125. The adult seat 115 in one form further has an adult seat-bottom 130 connected to the adult seatback 125 on the opposite end of the adult seat headrest 120. The adult seat 115 has an adult restraint 135 which may be positioned anywhere in the vehicle 105. In one example, the adult restraint 135 is attached directly to the adult seat 115.

The adult seat 115 transitions to a child seat 140. In one example, the integrated restraint system 100 transitions between the adult seat 115 and the child seat 140 by using components housed all or partially in the vehicle 105. The adult seat 115 converts to the child seat 140 without requiring the user to provide additional equipment. When the adult seat 115 of the integrated restraint system 100 transitions to the child seat 140, the child seat 140 includes a child seat headrest 145, a child seat back 150, a child seat booster 155, and a child restraint 160. The child seat 140 is housed within the adult seat 115. In one configuration, the adult seat 115 and the child seat 140 utilize the same parts of the integrated restraint system 100 when assembled. For instance, when the adult seat 115 transitions to the child seat 140, the adult seat headrest 120 of the adult seat 115 becomes the child seat headrest 145 of the child seat 140. In another instance, when the adult seat 115 changes to the child seat 140, the adult seatback 125 of the adult seat 115 becomes the child seat back 150 of the child seat 140. As another example, when the adult seat 115 transitions to the child seat 140, the adult seat-bottom 130 of the adult seat 115 becomes the child seat booster 155 of the child seat 140. Additionally, when the adult seat 115 morphs to the child seat 140, the adult restraint 135 of the adult seat 115 becomes the child restraint 160 of the child seat 140. The respective portions of the adult seat 115 convert into the respective portions of the child seat 140. The adult seat 115 can be manually and/or automatically transformed into the child seat 140.

The child restraint 160 in the illustrated example includes a harness 162 to secure an occupant of the child seat booster 155 such as a child. The harness 162 has one or more belts 163 that are coupled together to secure the occupant. The harness 162 in the illustrated example is a five-point type harness but other types of harnesses can be used.

The child seat 140 of the seat assembly 110 is located inside a stowable compartment 165. The stowable compartment 165 is configured to contain the child seat 140 when the seat assembly 110 is in the adult seat 115 position. The stowable compartment 165 of the seat assembly 110 conceals the components of the adult seat 115 when the adult seat 115 is not in use. In one example, the child restraint 160 is stowed within the adult seat 115 and is removed when the adult seat 115 transitions to the child seat 140. In another example, the integrated restraint system 100 includes a stowable compartment for each separate component of the child seat 140, including the child seat headrest 145, child seat back 150, child seat booster 155, and/or child restraint 160. The components are removed from the stowable compartment 165 when the child seat 140 is in use and the components are returned to the stowable compartment 165 when the child seat 140 is not in use. The integrated restraint system 100 shows a child restraint 160 that is separate than the adult restraint 135. The child restraint 160 is used for securing a passenger to the child restraint 160. The adult restraint 135 is used for securing a passenger to the adult seat 115. In other examples, the child restraint 160 and the adult restraint 135 are constructed of the same restraints. The adult restraint 135 and the child restraint 160 are configured to provide adequate restraint based upon the passenger.

FIG. 2 shows one variation of the seat assembly 110 of the integrated restraint system 100. The seat assembly 110 is in the child seat 140 position. In this example, the seat assembly 110 has a buckle 200 and a booster handle release lever 205 on the child seat 140. The booster handle release lever 205 has a lever that is pulled to facilitate conversion of the seat assembly 110 into the child seat 140. In one form, the child seat booster 155 is manually raised into the child seat 140 position, but in other forms, the child seat booster 155 is automatically raised to the child seat 140. As can be seen in FIG. 2, the booster handle release lever 205 remains on the child seat booster 155 after the seat assembly 110 has transitioned into the child seat 140. The placement of the booster handle release lever 205 allows the seat assembly 110 to transform back and forth between multiple configurations using the same booster handle release lever 205. The booster handle release lever 205 is located on the child seat booster 155 away from the child seat back 150 for case of access when a passenger is sitting in the child seat 140. The booster handle release lever 205 in this example is located in the middle of the child seat booster 155.

The child seat booster 155 is moveable from a stowed position where the child seat booster 155 is generally flush with the adult seat-bottom 130 to a boosted position where the child seat booster 155 protrudes from the adult seat-bottom 130 so as to accommodate the child. In one form, the child seat booster 155 is configured to automatically move to the boosted position when the booster handle release lever 205 is actuated. For instance, an actuator, such as a linear actuator, hydraulic piston, and/or spring, is used to move the child seat booster 155 to the boosted position. The booster handle release lever 205 can further be used to latch the child seat booster 155 in the stowed position when needed.

The seat assembly 110 has the buckle 200 connected to the child seat booster 155. The buckle 200 is used for fastening the restraints to secure the passenger. The buckle 200 is positioned on the child restraint 160. In certain other configurations, the adult restraint 135 has the buckle 200 attached. In this illustrative example, the buckle 200 is fastened manually. The buckle 200 is positioned between the legs of a passenger. The buckle 200 is attached to the child seat booster 155 by a portion of the child restraint 160. The child restraint 160 connected to the buckle 200 is protruding from the top surface of the child seat back 150 in order to provide slack to access the buckle 200 when a passenger is sitting in the child seat 140. In other examples, the child restraint 160 includes multiple fastening devices. In other examples, one or more buckles can be placed elsewhere on and/or in the seat assembly 110. The buckle 200 is configured to receive the child restraint 160 extending from the child seat back 150.

This illustrative example further includes a seat assembly attachment mechanism 210 connected to the child seat booster 155 of the child seat 140. The seat assembly attachment mechanism 210 is used for attaching or securing the seat assembly 110 to the vehicle 105. The seat assembly attachment mechanism 210 is configured to allow the seat assembly 110 to be removed or installed in the vehicle 105. A user could purchase a vehicle that does not possess the integrated restraint system 100 and can install the seat assembly 110 into the vehicle such that the integrated restraint system 100 is implemented and the seat assembly 110 is permanent within that vehicle.

The seat assembly attachment mechanism 210 is located between the seat assembly 110 and the floor of the vehicle 105. The seat assembly attachment mechanism 210 also facilitates movement of the seat assembly 110 from the vehicle 105. In this example, seat assembly attachment mechanism 210 has a grooved receiving mechanism 215 for connecting the seat assembly 110 to the vehicle 105. The grooved receiving mechanism 215 allows the seat assembly 110 to adjust its position within the vehicle 105 while remaining attached to the vehicle 105. The child seat headrest 145 of the child seat 140 is connected to a headrest side-support structure 220 which protrudes from the child seat headrest 145. The headrest side-support structure 220 is also attached to the child seat back 150 in this example. The connection of the headrest side-support structure 220 to both the child seat back 150 and the child seat headrest 145 in this example allows the surface of the headrest side-support structure 220 to sit flush with the both surfaces of the child seat headrest 145 and the child seat back 150. In some examples, the headrest side-support structure 220 protrudes from the child seat back 150 and is not connected to the child seat headrest 145.

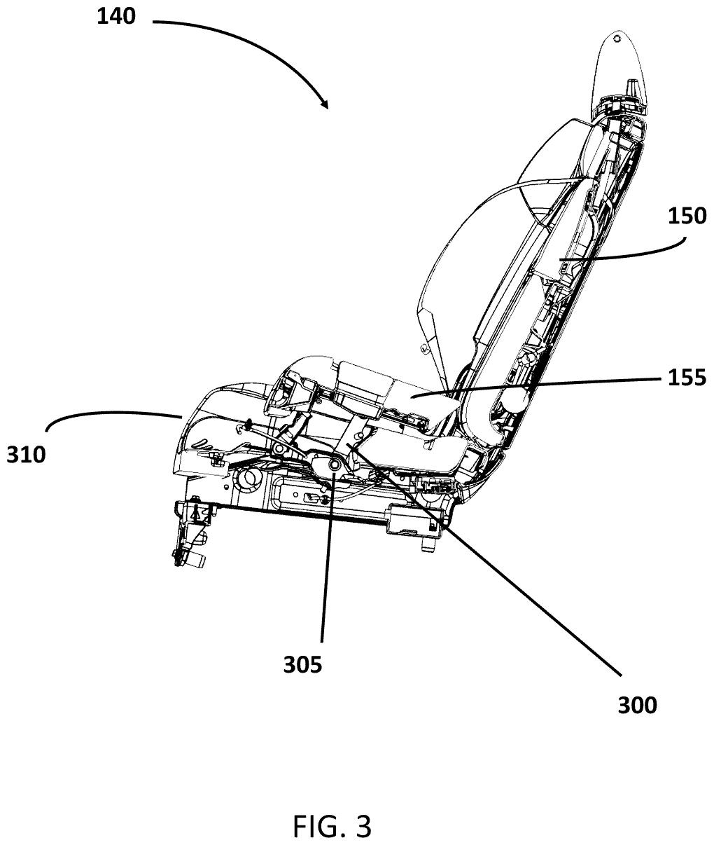

Turning to FIG. 3, the seat assembly 110 includes a seat adjustment support structure 300 connected to the child seat booster 155 of the child seat 140. The seat adjustment support structure 300 facilitates conversion from the adult seat 115 to the child restraint 160. In this example, the seat adjustment support structure 300 includes a linkage assembly 305 that allows multi-directional movement of the child seat booster 155 when transitioning into the child seat 140. The seat adjustment support structure 300 is housed within a seat bottom compartment 310. The linkage assembly 305 is configured to pivot and/or rotate when transitioning the child seat booster 155. The child seat booster 155 is configured to move vertically during transition. The linkage assembly 305 also allows the child seat booster 155 to move horizontally toward the child seat back 150. The movement of the child seat booster 155 facilitated by the linkage assembly 305 causes the surface of the child seat booster 155 to sit flush with the surface of the child seat back 150 when the seat assembly 110 is in the child seat 140 position. The angle of child seat back 150 of most chairs is angled slightly backward. The dual-directional movement capabilities of the child seat booster 155 helps prevent a gap between the child seat booster 155 and the child seat back 150. The seat adjustment support structure 300 is configured to provide the same capabilities of motion in reverse when transitioning the seat assembly 110 to the adult seat 115 position. The seat adjustment support structure 300 causes the child seat booster 155 to move directly away from the child seat back 150 when transitioning the child seat 140 to the adult seat 115. The seat adjustment support structure 300 further allows the child seat booster 155 to move vertically downward toward the floor of the vehicle 105. The multi-directional movement accounts for any needed angular shift to seat position, as opposed to only permitting linear single-directional movement. The multi-directional movement also allows the front surface of the adult seat-bottom 130 to sit flush when the seat assembly 110 is returned to the adult seat 115.

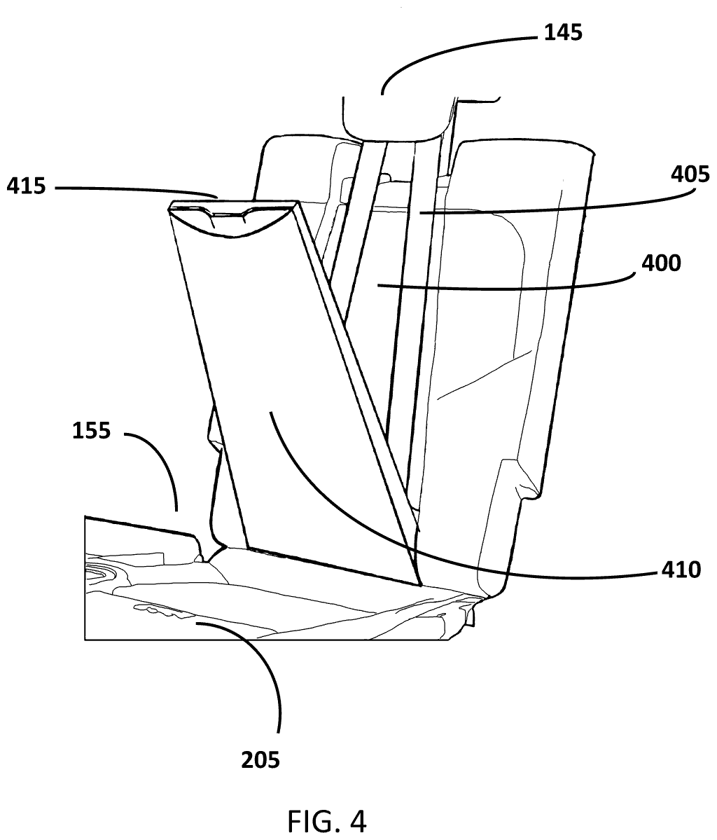

FIG. 4 displays a seatback compartment 400 defined within the adult seatback 125 of the adult seat 115. The seatback compartment 400 is configured to open by releasing a seatback door panel 410. The seatback compartment 400 is configured to conceal at least a portion of the child restraint 160 of the child seat 140 when the seat assembly 110 is the adult seat 115. In this illustrative example, the seatback compartment 400 includes a recessed child restraint 405 which is not visible when the seat assembly 110 is in the adult seat 115 position. In this iteration, the recessed child restraint 405 attached to the bottom of the child seat headrest 145 at two points. In other examples, the recessed child restraint 405 can be attached at a singular point or the recessed child restraint 405 can be attached at one point.

The recessed child restraint 405 extends toward the child seat back 150 and contains slack of the child restraint 160 in the seatback compartment 400. The seatback door panel 410 is activated and/or opened by activating a seatback activation handle 415. The seatback activation handle 415 is operated manually. The seatback door panel 410 opens toward the anterior of the seat assembly 110 and swings toward the floor of the vehicle 105. This configuration then allows the straps of the recessed child restraint 405 to be removed from the seatback compartment 400. The child seat headrest 145 is configured to move upward and downward in the vertical plane, allowing the child seat headrest 145 to conceal the seatback activation handle 415 until the child seat headrest 145 is lifted. The attachment to the child seat headrest 145 allows the recessed child restraint 405 to be removed form the seatback compartment 400 and to remain outside the seatback compartment 400 when the seatback door panel 410 is closed and seat assembly 110 has completed the transition to the child seat 140 position. The seatback door panel 410 is flush with the edges of the remainder of the child seat back 150 when the seatback door panel 410 is closed. The child seat back 150 can also be configured to conceal the seatback compartment 400 by other mechanisms. In other examples, the seatback door panel 410 opens from the side that is closer to the child seat booster 155 or is opened from one or more side.

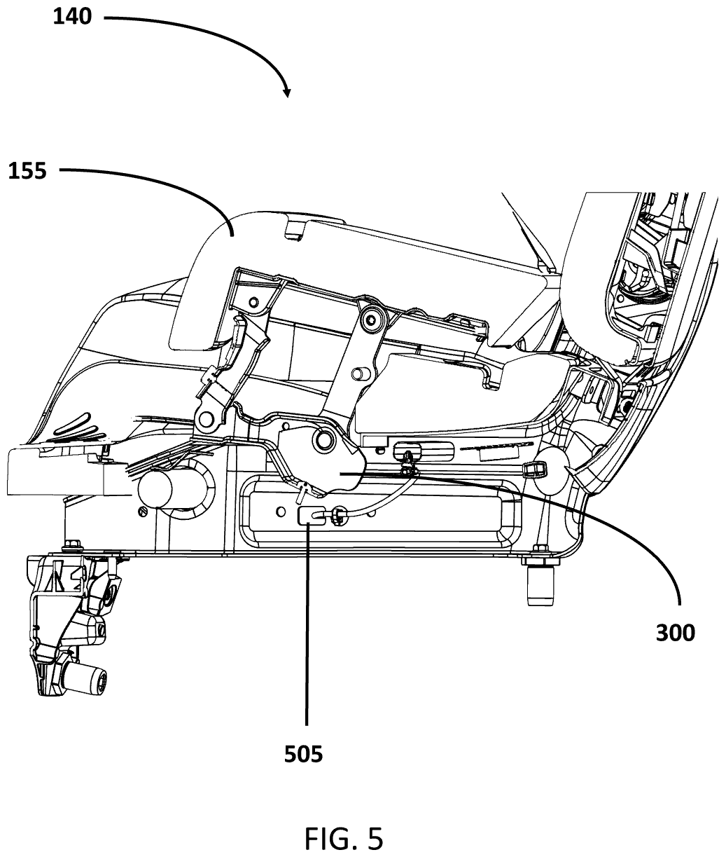

FIG. 5 shows a section of the adult seat 115 with the seat adjustment support structure 300 configured to attach to the child seat booster 155 at two points. As can be seen, the seat adjustment support structure 300 is configured to allow both attachment points to pivot while the seat assembly 110 is transitioning to the child seat 140. The child seat booster 155 includes a joint lever 505 configured to allow additional vehicle equipment to pass through the surface of the seat assembly 110 in order to allow the seat assembly 110 to operate with the other components of the vehicle 105.

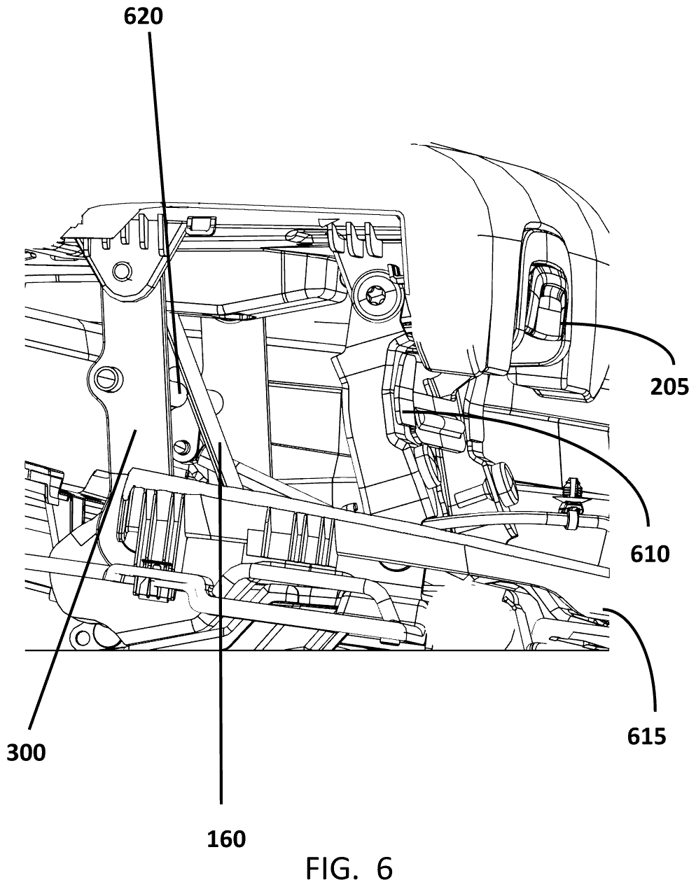

FIG. 6 shows the seat adjustment support structure 300 of the seat bottom compartment 310 configured to attach to the child seat booster 155 in four places. The four attachment points of the seat adjustment support structure 300 are configured to facilitate movement and support of the child seat booster 155. The front portions of the seat adjustment support structure 300 include a concave groove 610. In the illustrated example, the concave groove 610 is located on the front portion of the seat adjustment support structure 300. The concave groove 610 is facing forward in the child seat 140 from the perspective of a passenger sitting in the child seat 140. The seat assembly 110 is activated to transition to and from the adult seat 115 and the child seat 140 by manually pulling the booster handle release lever 205 on the front of the child seat booster 155 and lifting or pulling the child seat booster 155. When the child seat 140 transitions to the adult seat 115, the seat adjustment support structure 300 rotates causing the concave groove 610 to rotate toward the floor of the vehicle 105. The concave groove 610 is configured to receive a convex groove 615 located at the bottom of the seat bottom compartment 310. The connection of the seat adjustment support structure 300 to the bottom of the seat bottom compartment 310 at the concave groove 610 and the convex groove 615 helps facilitate securing the adult seat 115. The seat adjustment support structure 300 also includes a cross beam 620 connecting the right and left portions of the seat adjustment support structure 300. The cross beam 620 is configured to help ensure that the different sides of the seat adjustment support structure 300 move in unison as the seat assembly 110 is transitioning to and from the adult seat 115 and the child seat 140.

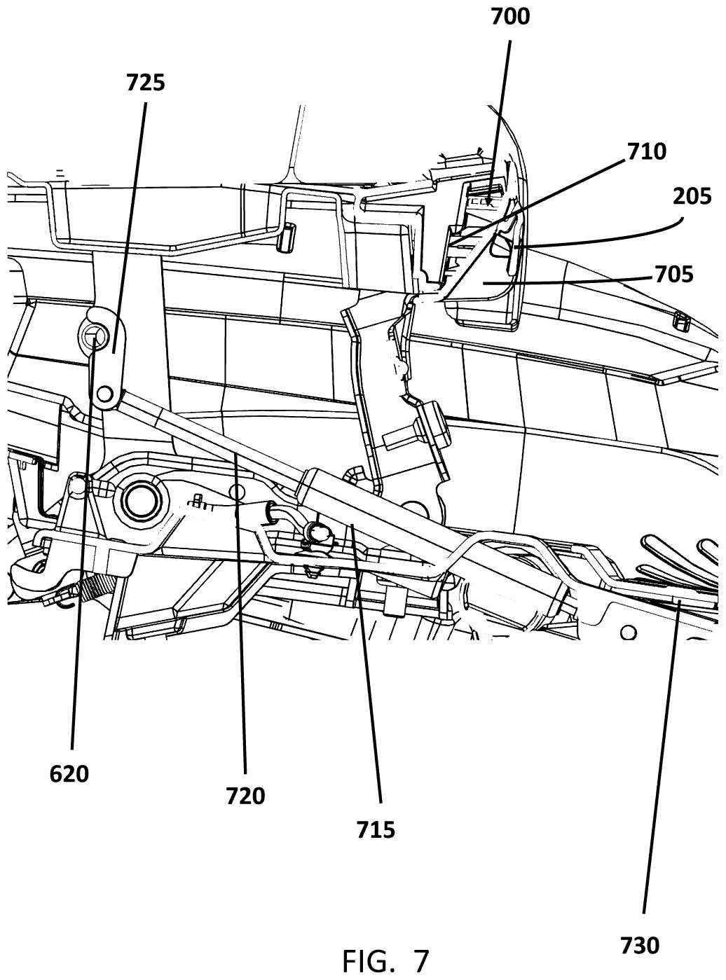

FIG. 7 shows an internal release mechanism 700 of the booster handle release lever 205 configured to include a clasp 705. Before the booster handle release lever 205 is activated, the clasp 705 prevents the child seat booster 155 from transitioning prior to the booster handle release lever 205 being activated. The clasp 705 extends down and/or below a portion of the internal release mechanism 700 in order to prevent the child seat booster 155 from unintentionally lowering when the seat assembly 110 is in the child seat 140 position. The clasp 705 is also positioned toward the anterior of the child seat 140 preventing the child seat 140 from unintentionally moving forward when the seat assembly 110 is in the child seat 140 position. When the booster handle release lever 205 is activated, the booster handle release lever 205 causes a release hammer 710 to press against the clasp 705 in order to cause an outward force upon the clasp 705. The outward force caused by the release hammer 710 acts to move the clasp 705 out of the way, allowing the child seat booster 155 to transition into the adult seat 115 or the child seat 140 respectively.

The seat bottom compartment 310 is shown to utilize a pneumatic arm 715. The pneumatic arm 715 acts to assist the child seat booster 155 in movement when the child seat booster 155 is moving to be placed in the child seat 140 position. The pneumatic arm 715 develops and applies a force to the adult seat 115 to cause the adult seat 115 to move in a predetermined path. In some examples, the pneumatic arm 715 applies the force to move the child seat booster 155 in a linear direction or to move the child seat booster 155 in a multi-directional manner. As one example, the pneumatic arm utilizes compressed air. In other aspects, the pneumatic arm 715 utilizes a spring to apply a force. Connected to the pneumatic arm 715 is an extendable arm portion 720. The extendable arm portion 720 permits the length of the pneumatic arm 715 to be adjusted as needed and to apply force to an object that is moving away from the base of the pneumatic arm 715. The extendable arm portion 720 is configured to shorten in instances when the adult seat 115 is deployed and lengthen in instances when the child seat 140 is deployed. The pneumatic arm 715 is connected to the cross beam 620 by a rotatable connection clasp 725. The rotatable connection clasp 725 is configured to rotate about the cross beam 620 in order to facilitate connected while the child seat booster 155 or the adult seat-bottom 130 is being moved. The rotational nature of the rotatable connection clasp 725 aids the pneumatic arm 715 in applying multi-directional force. The rotatable connection clasp 725 remains connected when the pneumatic arm 715 is providing force in the horizontal direction. The rotatable connection clasp 725 remains connected when the pneumatic arm 715 is provided force in the horizontal direction.

FIG. 7 also depicts a footrest 730 connected to the seat assembly 110, which is revealed after the adult seat 115 transitions to the child seat 140. When a passenger is sitting in the adult seat 115, the feet of the passenger will rest naturally on the floor of the vehicle 105 before them. When the adult seat 115 transitions to the child seat 140, the feet of the passenger will not necessarily rest at the same place as for the adult seat 115. FIG. 7 shows that when the seat assembly 110 is transitioned into the child seat 140, the footrest 730 is revealed to provide a separate place for the passenger to set their feet. In many cases, the passenger for the child seat 140 will be smaller in stature than the adult seat 115. The footrest 730 is located closer to the ceiling of the vehicle 105. The footrest 730 is also located toward the posterior end of the child seat 140.

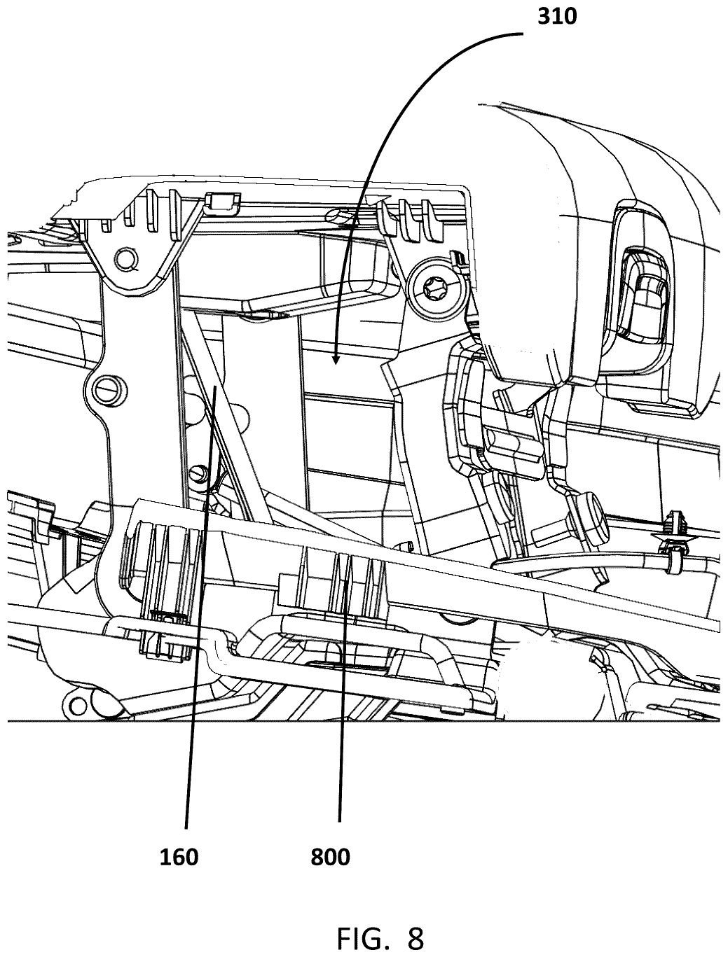

As can be seen in FIG. 8, the child restraint 160 extends downward into the seat bottom compartment 310 toward the floor of the vehicle 105. The child restraint 160 connects to tightening device a tightening mechanism 800. The tightening mechanism 800 includes a ratcheting mechanism configured to tighten the child restraint 160 by reducing the slack provided on the exterior of the seat bottom compartment 310. In another embodiment, the child restraint 160 attaches to a fixed receiving device that helps maintain a uniform belt length.

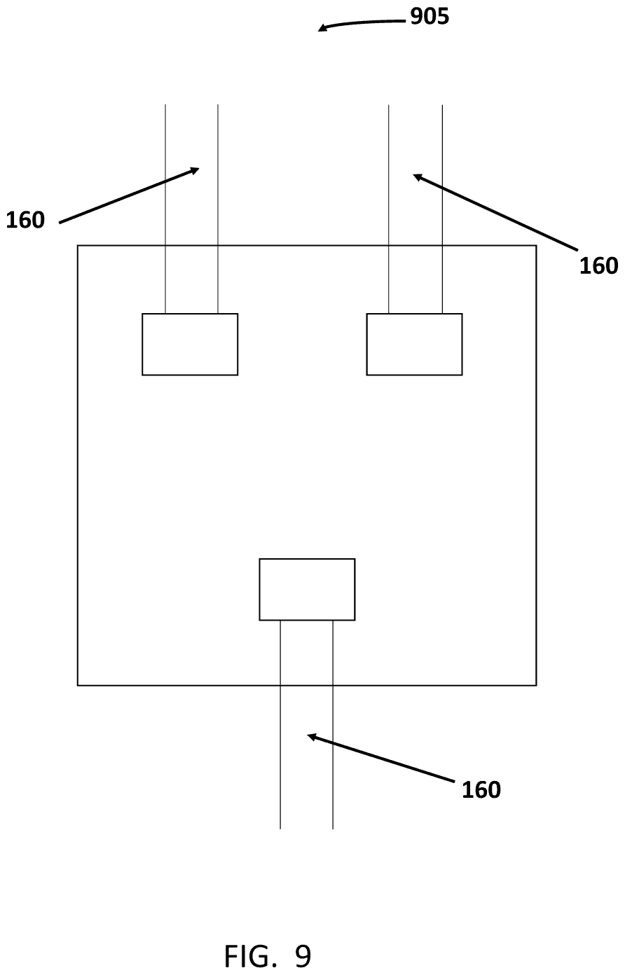

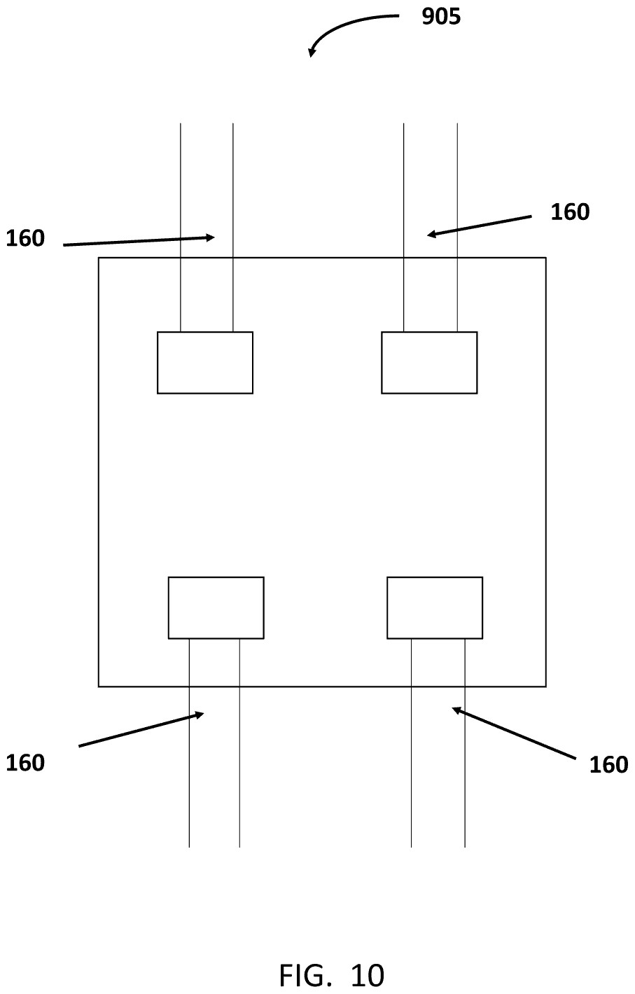

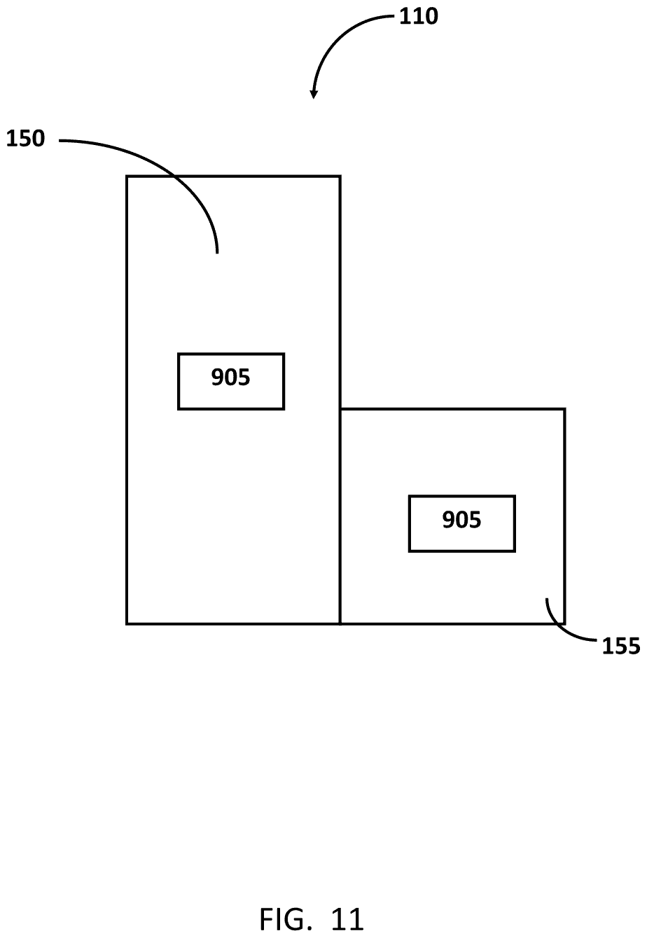

FIGS. 9, 10, and 11 depict a restraint tightening mechanism 905 used to tighten the child restraint 160 when in use by a passenger. The restraint tightening mechanism 905 is configured to remove slack from the system in order to facilitate tightening. In another example, the restraint tightening mechanism 905 applies a downward force to the child restraint 160 to pull the child restraint 160 tighter to the passenger. FIG. 9 shows the restraint tightening mechanism 905 is constructed to receive two straps of the child restraint 160 at the end closer to the child seat headrest 145, and extends a singular strap of the child restraint 160 connected to the restraint tightening mechanism 905 toward the floor of the vehicle 105. Additionally alternatively, the restraint tightening mechanism 905 is configured to receive two straps of the child restraint 160 connected closer to the child seat headrest 145, and extends two straps of the child restraint 160 downward toward the floor of the vehicle 105 as depicted in FIG. 10. In some embodiments, the child seat back 150 and child seat booster 155 both include a restraint tightening mechanism 905.

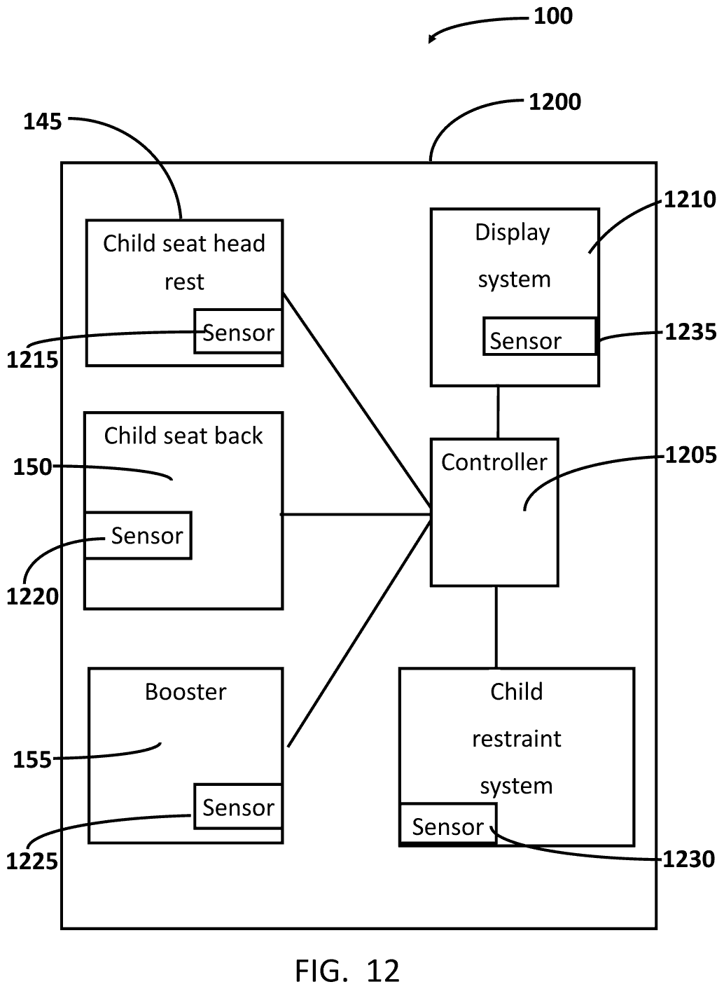

FIG. 12 is a diagram of an automated configuration of the integrated restraint system 100. This figure demonstrates that an automated system 1200 is operatively connected to at least one sensor in the seat assembly 110. This example shows a headrest sensor 1215, a seatback sensor 1220, a booster sensor 1225, a child restraint sensor 1230, and/or a display system sensor 1235. In another example, the sensor 180 is active in the child seat 140 but not the adult seat 115 and vice versa with the sensor 180 active in the adult seat 115 but not the child seat 140.

The automated system 1200 is equipped with a controller 1205 that dictates the function of the system. The controller 1205 is operatively connected to the child seat headrest 145, the child seat back 150, and/or the child seat booster 155. Each sensor 180 collects information about the automated system 1200 and the environment of the automated system 1200 in order to relay information to the controller 1205. The controller 1205 is equipped with a display system 1210 that communicates visual information concerning the automated system 1200 to the user.

Additionally, the automated system 1200 is configured to facilitate automation for any portion of the transition from the adult seat 115 configuration to the child seat 140 configuration. In the present example, the entire process of transitioning from the adult seat 115 to the child seat 140 is automated via the automated system 1200. Alternatively additionally, securing the child passenger to the seat in the child seat 140 position is automated but the adult seat 115 transitions back and forth to the child seat 140 manually. Alternatively, the transitioning of the seat assembly 110 from the child seat 140 configuration back to the adult seat 115 configuration is automated but the child restraint 160 is tightened manually in order to secure the passenger. In another, the display system 1210 is automated and the rest of the seat assembly 110 is converted manually between the adult seat 115 and the child seat 140.

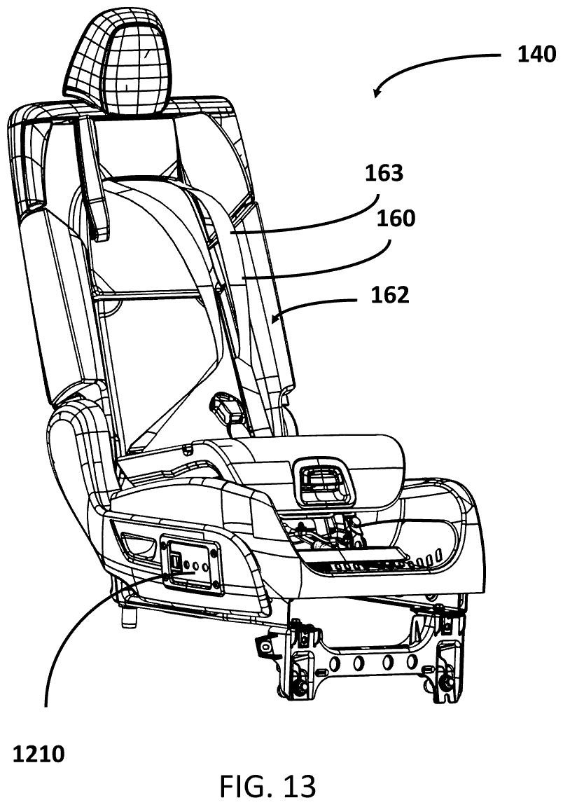

The child seat 140 in FIG. 13 shares several features in common with the previously discussed design. For instance, the child restraint 160 in the illustrated example includes the harness 162 to secure the occupant of the child seat booster 155 such as the child. The harness 162 has the belts 163 that are coupled together to secure the occupant. The harness 162 in the illustrated example is a five-point type harness but other types of harnesses can be used. For a description of these common features, please refer to the prior discussion.

As illustrated in FIG. 13, the display system 1210 is placed on the side of the seat assembly 110. The display system 1210 affixed to the seat assembly 110 includes light indicators to communicate the status of certain aspects of the display system 1210. The lights of the display system 1210 operate to communicate multiple categories of information related to the operation of the automated system 1200 and the seat assembly 110. For instance, the display system 1210 provides a green light as an indicator that the seatbelt is properly fashioned. Additionally, another light indicates that the child seat 140 is fully or not fully configured. Another light indicates that there is a passenger in the child seat 140 or there is not a passenger in the child seat 140. Yet another light may indicate that the child seat 140 is properly buckled and/or sufficiently tight or may indicate that the child seat 140 is not properly buckled and/or sufficiently tight. In this configuration, the display system 1210 is also visible when the seat assembly 110 is in the adult seat 115 configuration.

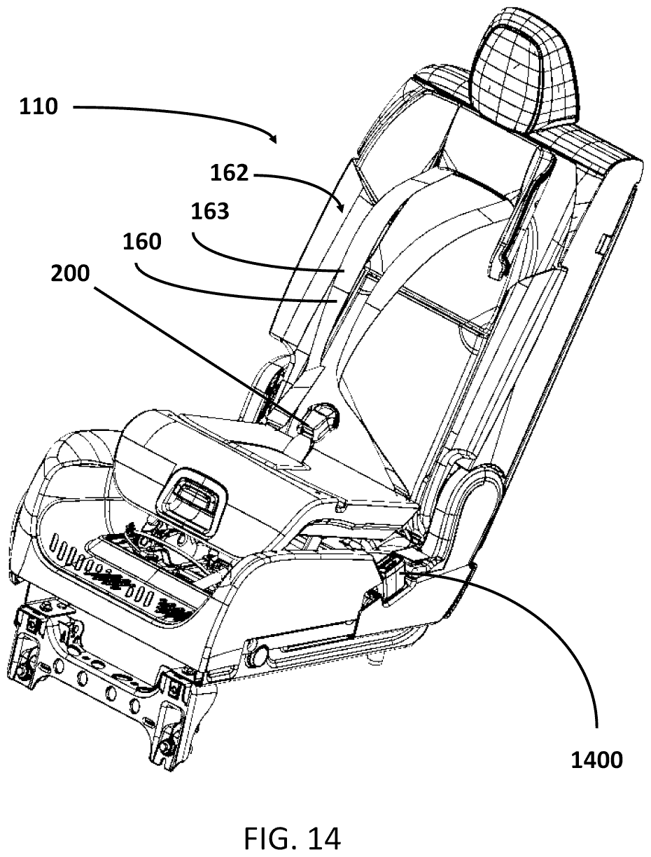

In some embodiments, the buckle 200 is provided in multipole locations including multiple locations on the seat assembly 110. FIG. 14 shows an example with two locations for the buckle, including an adult buckle 1400. This exemplary view shows that the seat assembly 110 has a seatbelt buckle to be used in the adult seat 115 configuration and a separate buckle to be used in the child seat 140 configuration. The adult buckle 1400 that is part of the adult seat 115 configuration is located on the lateral left-hand portion of the adult seatback 125 of the adult seat 115. Placing the seatbelt of the adult seat 115 on the left lateral side facilitates right-handed passengers in securing their seatbelt. As is shown in FIG. 14, this seatbelt buckle is still visible when the seat assembly 110 is in the child seat 140 configuration. The buckle 200 purposed for securing the passenger in the child seat 140 configuration is placed on the surface of the child seat booster 155 near the passenger. The buckle 200 of the child seat 140 is located toward the center of the seat assembly 110 so that the buckle 200 may be fastened between the legs of the passenger.

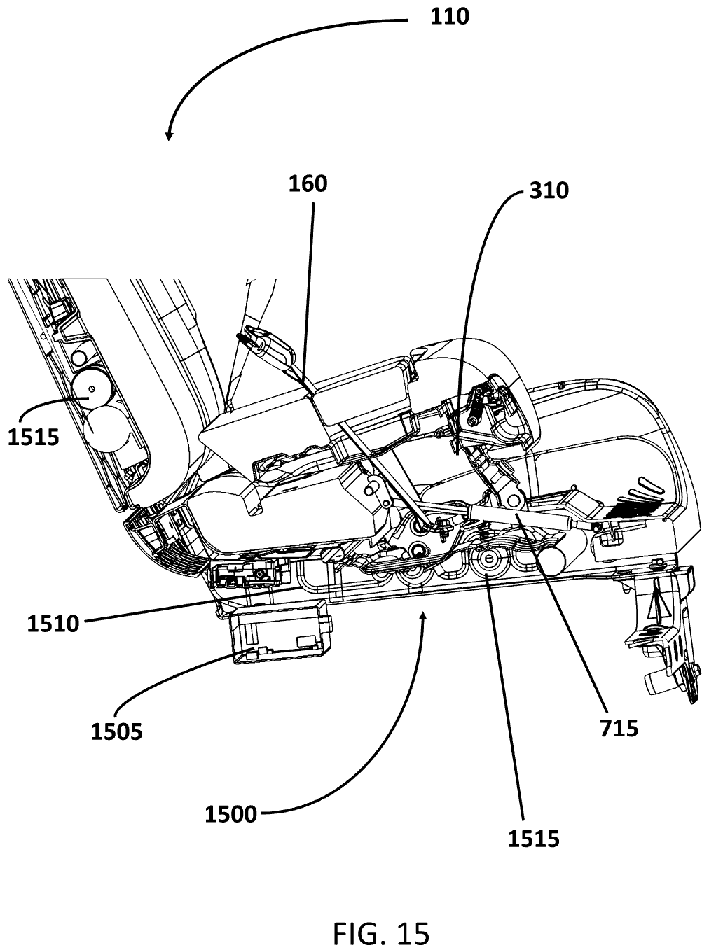

In the automated configuration, the seat assembly 110 is equipped with an automation mechanism 1500 to conduct the movement of the seat assembly 110 between forms of the adult seat 115 and/or the child seat 140 as illustrated in FIG. 15. The automation mechanism 1500 includes a motor 1505 used to store and supply energy for the automation mechanism 1500 to apply necessary forces to the automation mechanism 1500. The automation mechanism 1500 includes the pneumatic arm 715 to stabilize and control movement of the seat assembly 110. The pneumatic arm 715 is automated by the controller 1205 and the motor 1505. The motor 1505 is located within the seat bottom compartment 310 in FIG. 15. In other examples, the motor 1505 is placed outside the seat bottom compartment 310. The motor 1505 is connected to the movement mechanism such as the pneumatic arm 715 via a wiring 1510. The wiring 1510 in this example is an electrical motor but other motors can be used. The automation mechanism 1500 also functions to assist in tightening the child restraint 160 to secure the passenger. Tightening the child restraint 160 is aided by a connection to the slack removal mechanism 1515 and implementation of the slack removal mechanism 1515. The slack removal mechanism 1515 includes rolling coils that remove slack by from the child restraint 160 by rotating to occupy more slack in the slack removal mechanism 1515, thereby causing less slack to be available on the outer surface of the seat bottom compartment 310 and/or available to the passenger.

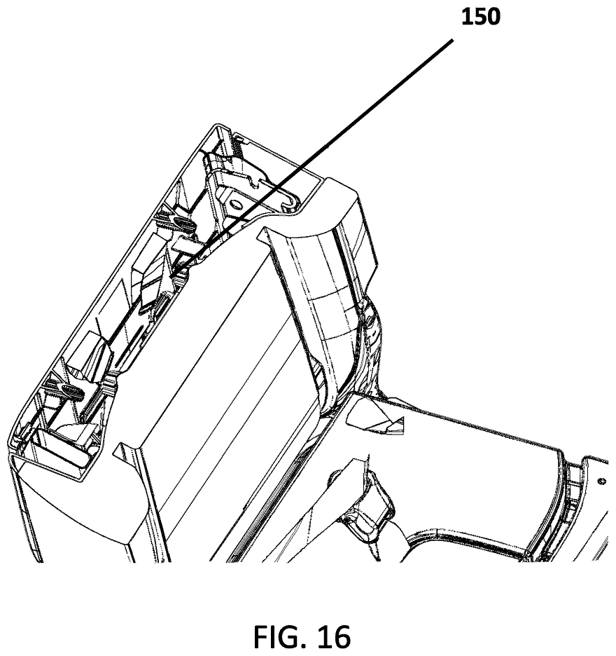

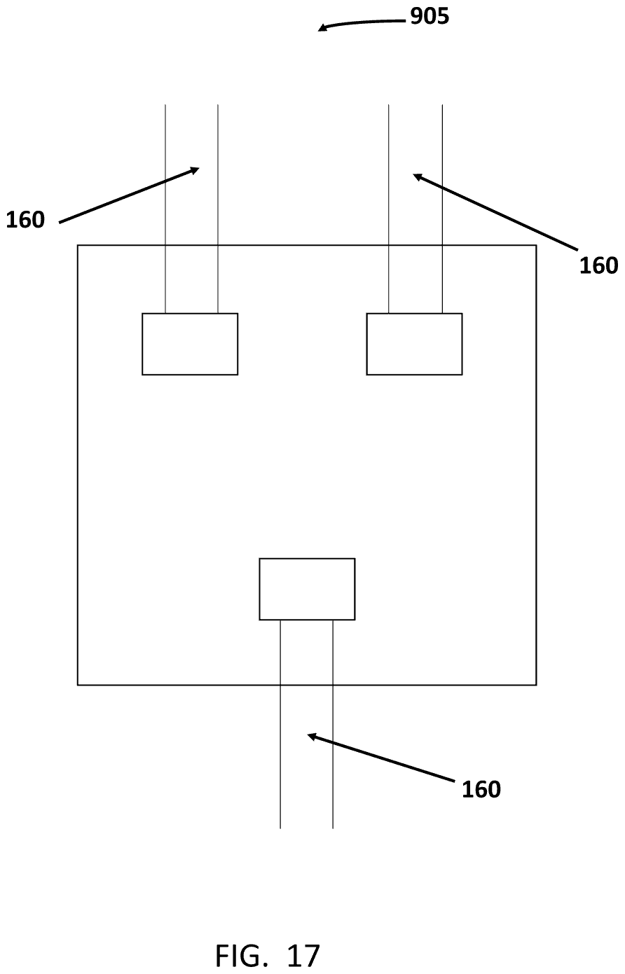

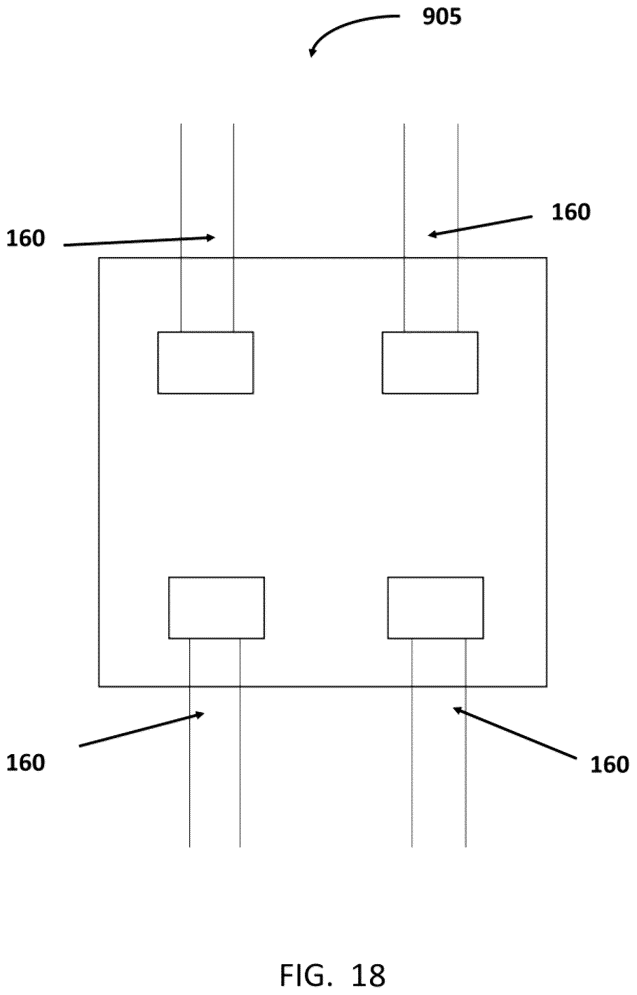

FIGS. 16, 17, and 18 depict the use of a restraint tightening mechanism 905 used to tighten the child restraint 160 when in use by a passenger. The restraint tightening mechanism 905 is configured to remove slack from the system in order to facilitate tightening. In another example, the restraint tightening mechanism 905 applies a downward force to the child restraint 160 to pull the child restraint 160 tighter to the passenger. The restraint tightening mechanism 905 is integrated in child seat back 150, as can be seen in FIG. 16. Turning to FIG. 17, the restraint tightening mechanism 905 is constructed to receive two straps of the child restraint 160 at the end closer to the child seat headrest 145, and extends a singular strap of the child restraint 160 connected to the restraint tightening mechanism 905 toward the floor of the vehicle 105. Additionally alternatively, the restraint tightening mechanism 905 is configured to receive two straps of the child restraint 160 connected closer to the child seat headrest 145, and extends two straps of the child restraint 160 downward toward the floor of the vehicle 105 as depicted in FIG. 18. In some embodiments, the child seat back 150 and child seat booster 155 both include a restraint tightening mechanism 905.

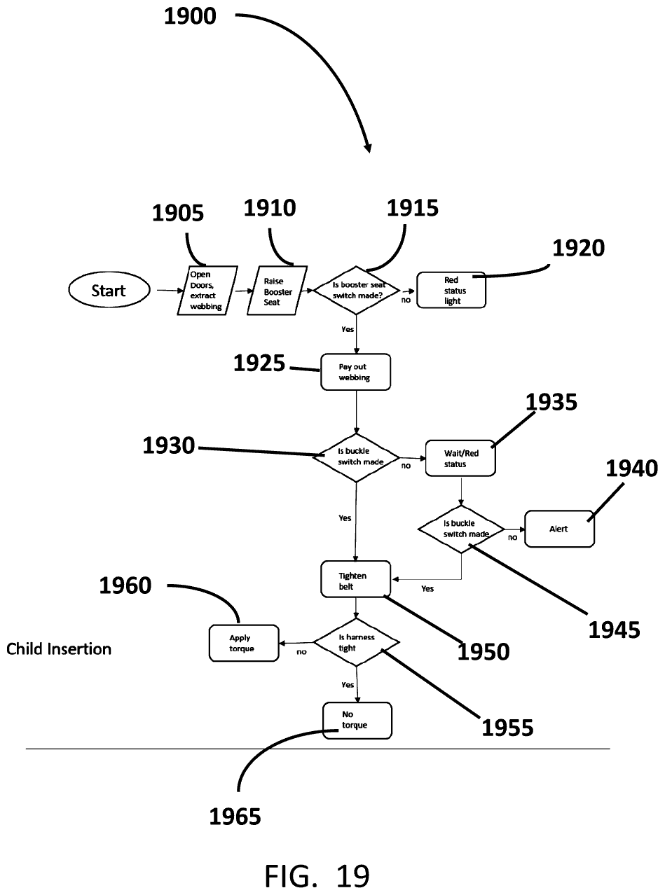

FIG. 19 contains a flowchart 1900 showing a method of securing a child passenger in the seat assembly 110. The method includes preparing the seat assembly 110 for child insertion and/or securing the child by a method of steps and logic inquiries. The flowchart shows A stage 1905 that begins the process by opening the doors revealing that the webbing of the stowable compartment 165 is available to be extracted. In stage 1910, the booster seat such as the child seat booster 155 is raised and/or shifted. In stage 1915 the booster seat is not in the proper position. If the system indicates that the child seat booster 155 is not in the proper position, the integrated restraint system 100 moves to a stage 1920 and the display indicates that the child seat booster 155 is not in the proper position. For example the integrated restraint system 100 uses a red light to indicate that the child seat booster 155 is not in the proper position. The red light is located on the display system 1210 but can be located elsewhere in other iterations. If the booster seat has been switched to the child seat 140 position, the system moves to stage 1925. The integrated restraint system 100 causes the seat assembly 110 to pay out the webbing of the child restraint 160. In stage 1930, the integrated restraint system 100 inquires whether the buckle 200 has been switched. If the buckle 200 has not been switched, an indicator at stage 1935 will communicate that the buckle 200 has not been switched, and an alert is provided in stage 1940. As shown in stage 1945, the integrated restraint system 100 will again inquire whether the buckle 200 has been switched. After a period of time, if the buckle 200 is not properly in place, the integrated restraint system 100 provides an alert to the user to indicate that the buckle 200 is not properly positioned and/or switched. The alert is visual but can also be audio. The status marker pertaining to the buckle 200 is another, separate light than the light in stage 1920. Once the buckle 200 has been switched, the flowchart 1900 progresses to a stage 1950 to tighten the belt. The flowchart 1900 will next inquire, in stage 1955, whether the harness is sufficiently tight. If the harness is not yet tight enough, the flowchart 1900 dictates that torque is applied to the child restraint 160 to tighten the system at a stage 1960. The system may be tightened by gradually removing slack from the child restraint 160. Once the harness is properly secured, the flowchart 1900 moves to stage 1965 and stops applying torque integrated restraint system 100 to the child restraint 160.

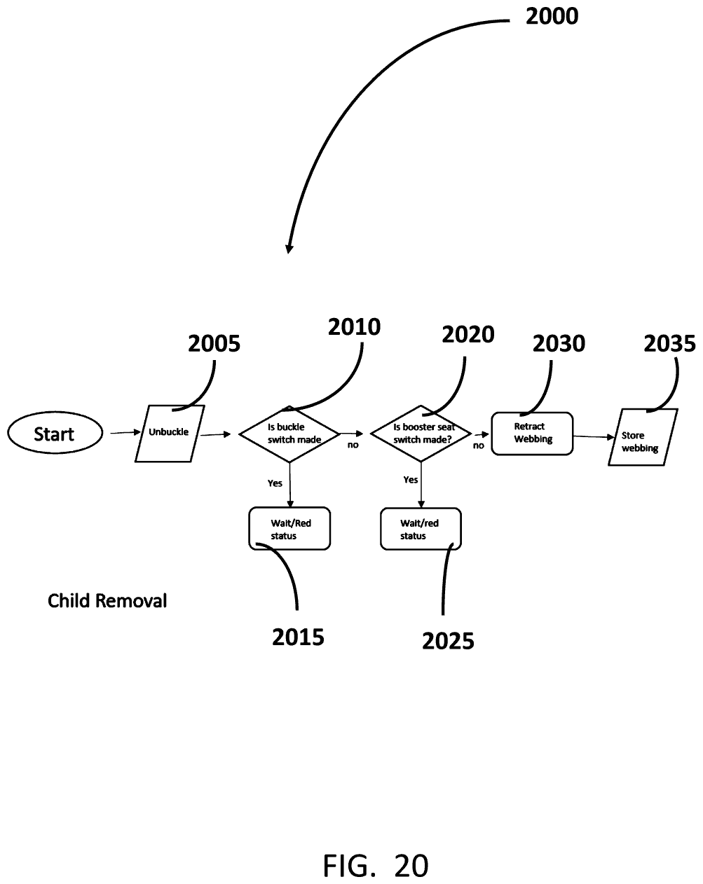

After the integrated restraint system 100 is no longer in use to secure a child, the system will occasionally need to switch back to the child seat 140. Methods and aspects of the integrated restraint system 100 used for removing the child and managing the integrated restraint system 100 are depicted in FIG. 20. FIG. 20 introduces a flowchart 2000 used for removing the child and retiring the seat assembly 110 to the adult seat 115. The child usually must be safely removed from the seat assembly 110 before the seat assembly 110 can switch back to adult seat 115. At stage 2005, the buckle 200 is unfastened. The integrated restraint system 100 uses the sensor 180 to detect the status of the child seat booster 155 in stage 2010. If the buckle 200 is in the child seat 140 position, the flowchart 2000 dictates that the system will move to a stage 2015 to wait for a period of time and/or communicate that the buckle 200 has not yet been switched back. If the sensor 180 indicates that the buckle has been switched back to the original position, the system will progress to stage 2020 and inquire whether the booster seat has been switched back to the original position of the adult seat 115 at stage 2020. If the booster has not been switched, the system will progress to stage 2025 and wait for a period of time as well as provide alerts, such as via a red light. If the booster seat has been switched, stage 2030 dictates that the webbing will begin to retract. The stage 2035 concludes the sequence by storing the webbing.

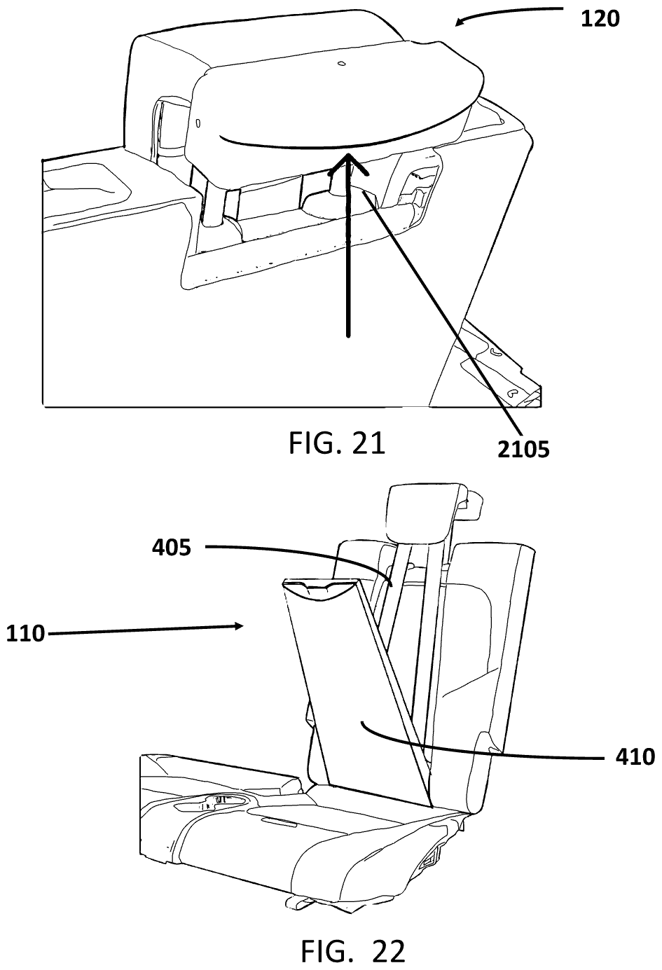

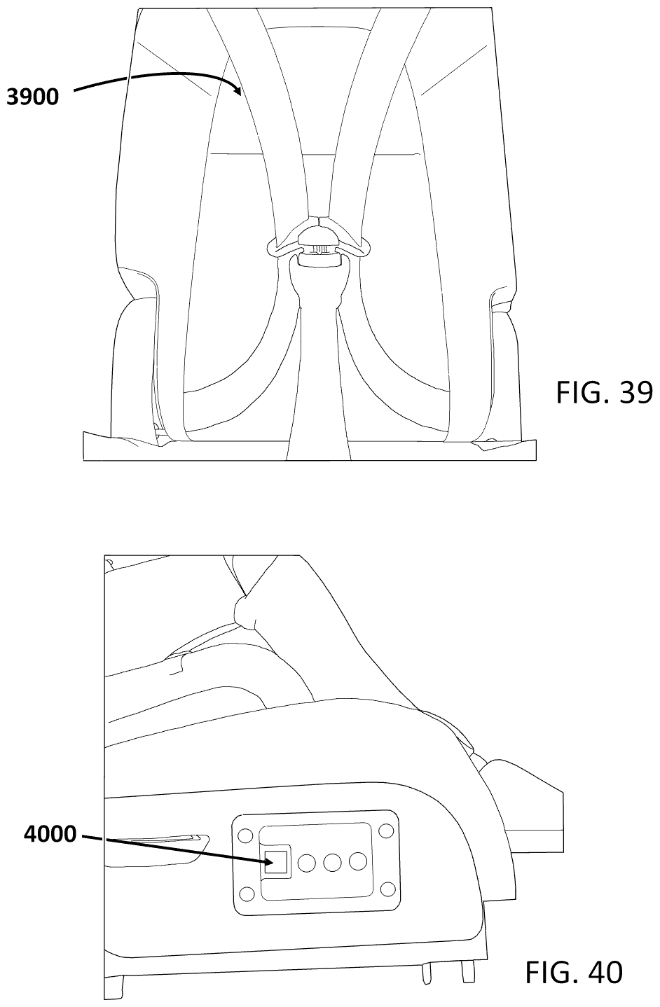

FIGS. 21 through 51 demonstrate in further detail certain aspects of a method for preparing a car seat to support a child and/or securing the child. FIGS. 21 through 51 also show certain aspects of removing a child from a car seat and retiring the car seat to the prior configuration to facilitate adult passengers. FIGS. 21 through 29 constitute one exemplary method of transitioning the seat assembly 110 from the adult seat 115 configuration to the child seat 140 configuration, and/or placing a child passenger in the child seat 140, and/or removing the child passenger from the child seat 140, and returning the child seat 140 back into the adult seat 115 configuration. FIGS. 30 through 38 constitute another exemplary method of transitioning the seat assembly 110 from the adult seat 115 configuration to the child seat 140 configuration, and/or placing a child passenger in the child seat 140, and/or removing the child passenger from the child seat 140, and returning the child seat 140 back into the adult seat 115 configuration. FIGS. 39 through 51 depict other aspects of the integrated restraint system 100.

FIGS. 21 through 29 constitute one exemplary method of transitioning the seat assembly 110 from the adult seat 115 configuration to the child seat 140 configuration and/or placing a child passenger in the child seat 140. FIG. 21 shows a headrest handle release 2105 located on the posterior surface of the adult seat headrest 120. Once the headrest handle release 2105 is engaged, the adult seat headrest 120 is lifted away from the adult seatback 125 to provide a gap or opening between the adult seat headrest 120 and the adult seatback 125. Pulling the headrest handle release 2105 allows the child restraint child restraint 160 to move freely throughout the system. In other examples, the headrest handle release 2105 is located in other positions on the seat assembly 110 such as the anterior surface of the adult seat headrest 120. FIG. 21 shows the adult seat headrest 120 connected to two poles. The poles extend toward the adult seatback 125 and are operatively connected to the adult seatback 125 through two openings configured to receive the poles and connect the adult seat headrest 120 to the adult seatback adult seatback 125. The connection of the adult seatback 125 to these poles allows the adult seat headrest 120 to move vertically while still being operatively engaged to the adult seatback adult seatback 125.

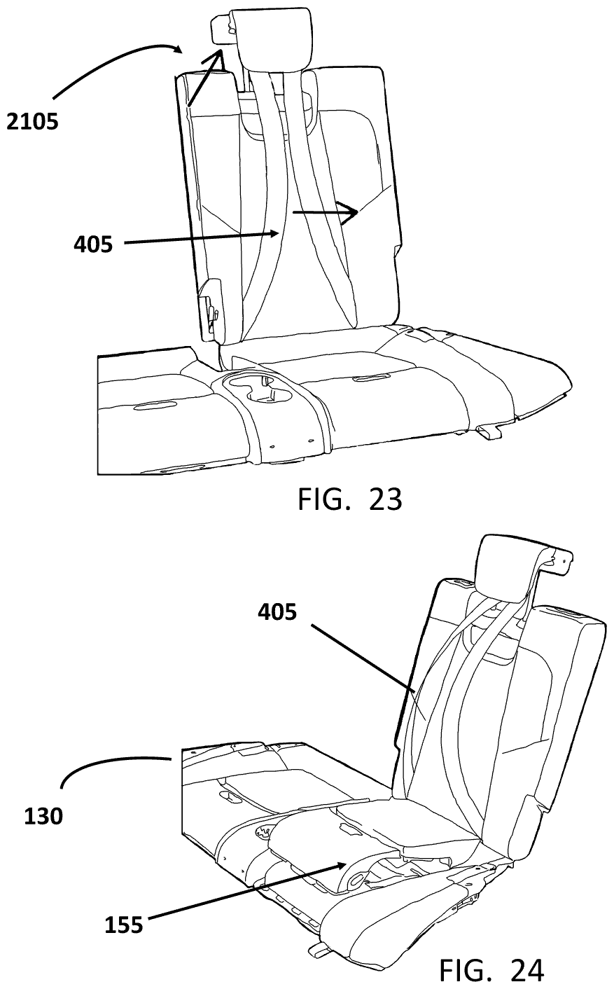

FIG. 22 depicts the seatback door panel 410 housed within the adult seatback 125. The seatback door panel 410 is opened to reveal the recessed child restraint 405, which is stowed in the seatback compartment 400 housed within the adult seat 115. This illustrative example includes a cushioned door panel which opens from the top and rotates downward to reveal two straps. The seatback door panel 410 is defined within the seat assembly 110. When the seatback door panel 410 is closed, it sits flush with the remainder of the seat assembly seat assembly 110. FIG. 23 demonstrates removing the recessed child restraint 405 out of the seatback compartment 400 while engaging the headrest handle release 2105 to allow slack in the system. The seatback door panel 410 is then shut. The edges of the seatback door panel 410 are flush with the child seat back 150 when the seat assembly 110 is in the child seat 140 configuration.

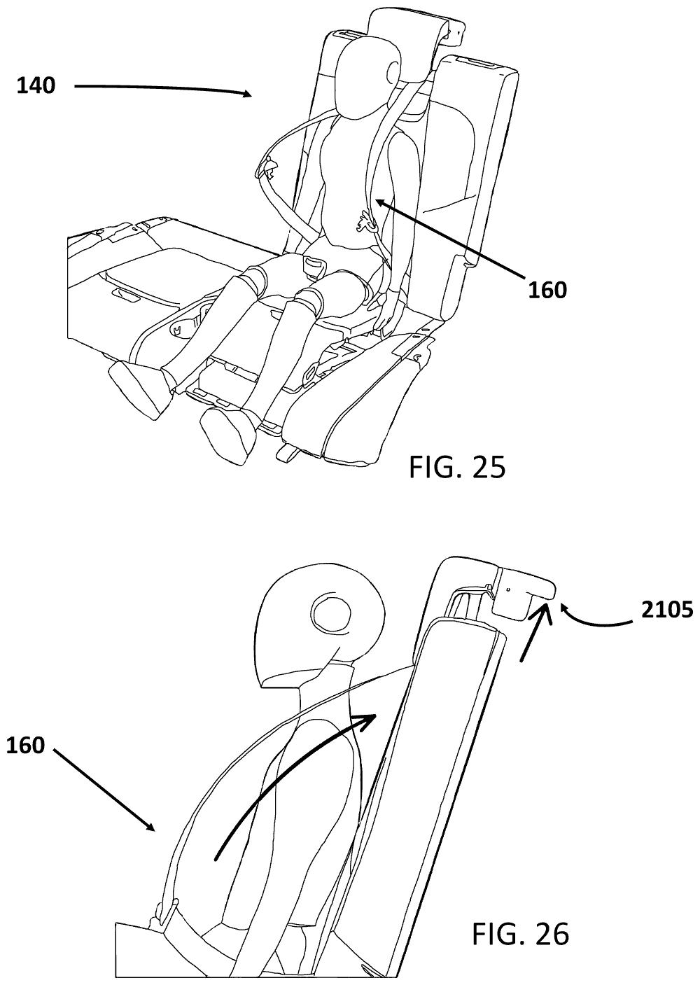

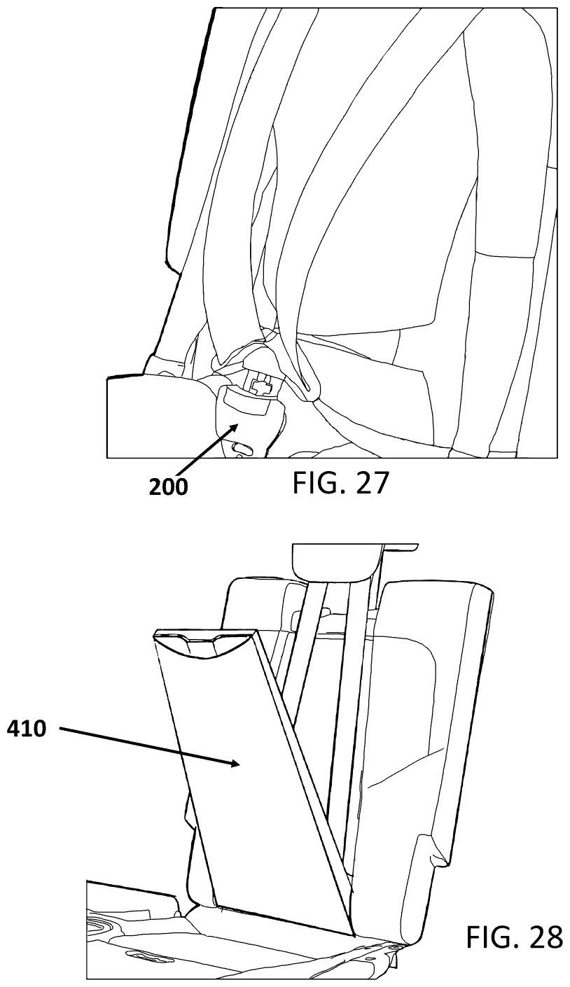

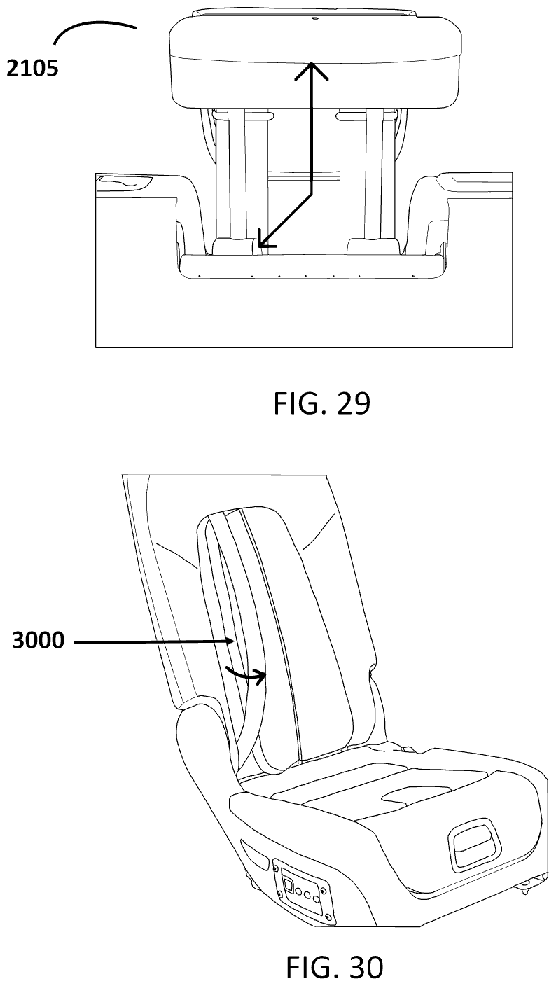

Turning to FIG. 24, once the doors of the seatback door panel 410 are shut and the recessed child restraint 405 is removed from the seatback compartment 400 the booster handle release lever 205 is engaged to initiate transitioning the adult seat-bottom 130 to the child seat booster 155. As can be seen in FIG. 25, the child passenger is then be placed in the child seat 140. The child restraint 160 is placed over the shoulders of the child passenger and the child restraint 160 extends around the shoulders of the child to secure the child. FIG. 26 demonstrates that once the buckle 200 is latched, the user pulls on the harness to secure the child restraint 160 tighter around the hip area of the child passenger. The user engages the headrest handle release 2105 to pull the slack out of the system. This acts to secure the child safely and gently. FIG. 27 shows the buckle 200 now unfastened. Once the buckle 200 is unfastened, the restraints are loosened. In some embodiments loosening the child restraint 160 will require engaging the headrest handle release 2105 in order to allow slack to move freely throughout the system. Turning to FIG. 28, the child restraint 160 is again returned to the seatback compartment 400, causing the child restraint 160 to no longer be in view. The seatback door panel 410 is then closed. The surface of the seatback door panel 410 is flush with the adult seatback 125, causing the upholstery of the adult seatback 125 to appear continuous. Regarding FIG. 29, the headrest handle release 2105 is engaged and the headrest is lowered. This example also requires engaging the mechanism that attaches the adult seat headrest 120 to the adult seatback 125 in order to unlock the adult seat headrest 120 so that it is able to move.

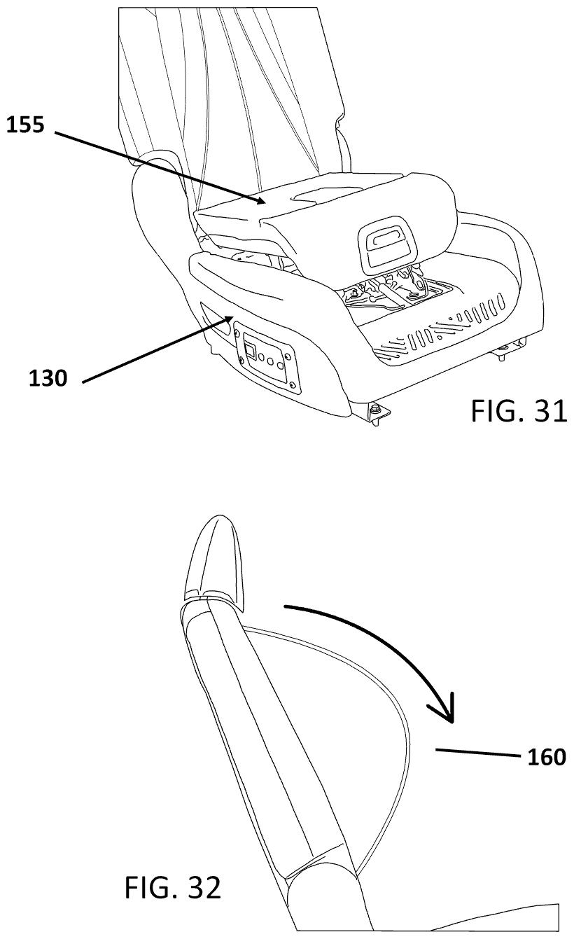

FIGS. 30 through 38 constitute another exemplary method of transitioning the seat assembly 110 from the adult seat 115 configuration to the child seat 140 configuration, and/or placing a child passenger in the child seat 140, and/or removing the child passenger from the child seat 140, and returning the child seat 140 back into the adult seat 115 configuration. FIG. 30 shows that the seatback door panel 410 is configured to include a winged door panel 3000 that opens from the distal portion of the seatback door panel 410. The seatback door panel 410 is located in the center of the adult seatback 125. Next, in FIG. 31 the adult seat-bottom 130 of the adult seat 115 is engaged to transition to the child seat booster 155 of the child seat 140. The child seat booster 155 is defined within the adult seat-bottom 130 when the seat assembly 110 is in the adult seat 115 position. The child seat booster 155 is configured to move in the vertical plane and/or the horizontal plane and/or a combination of the two. The child seat booster 155 is configured to first move in the vertical plane toward the child seat headrest 145 and then the horizontal plane in the direction of the child seat back 150. The child seat booster 155 may also be configured to move first in the horizontal plane in the direction of the child seat back 150 toward the posterior of the seat assembly 110. In another embodiment, the child seat booster 155 is configured to move diagonally to travel equally through the horizontal and vertical planes simultaneously.

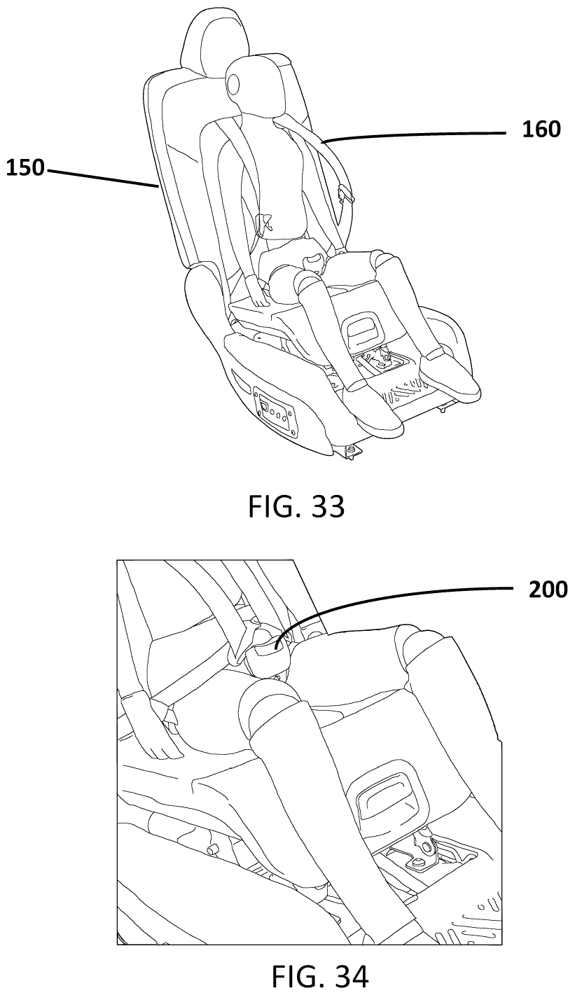

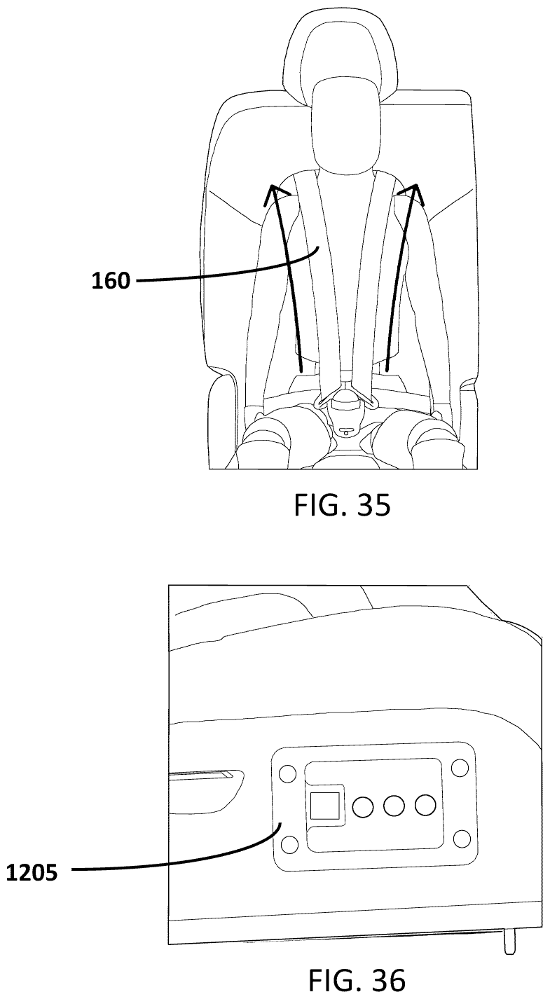

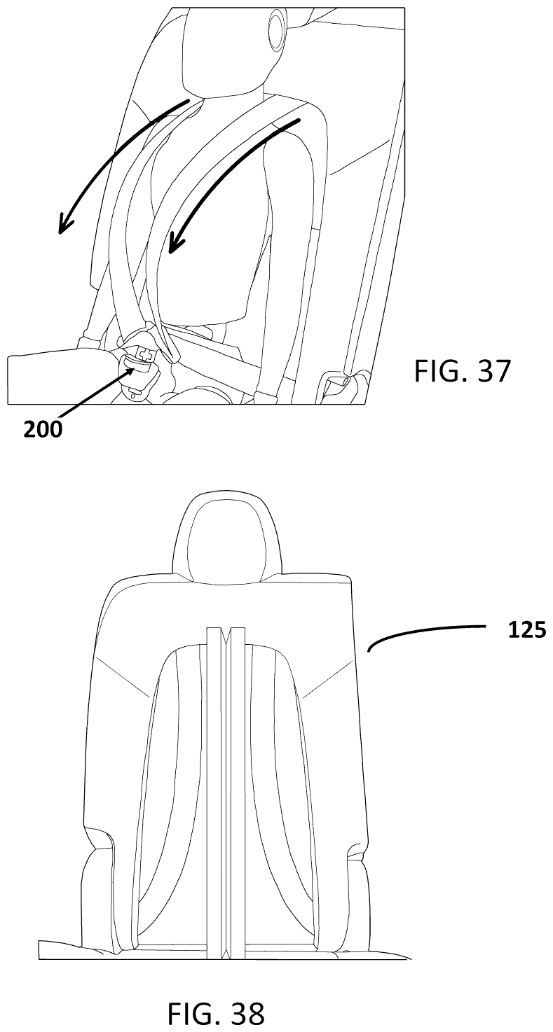

Turning to FIG. 32, once the child seat booster 155 has been raised, the child restraint 160 loosens automatically and the user removes the straps out of the seatback compartment 400. As can be seen in FIG. 33, the child passenger is then placed in the child seat 140. The arms of the child passenger are placed through the child restraint 160. In this embodiment, the child restraint 160 includes two straps protruding from the child seat back 150. The buckle 200 is latched to fasten the child restraint 160, as demonstrated in FIG. 34. The harness is then pulled upward to tighten around the hip area of the child passenger. Next, as seen in FIG. 35, once the buckle 200 is latched, the child restraint 160 is aligned over the shoulders of the child passenger. FIG. 36 depicts an embodiment of the controller 1205. In this embodiment, the controller 1205 includes three lights that are lit to indicate that the child passenger is properly secured. Turning next to FIG. 37, to release the child passenger from the child seat 140, the buckle 200 is undone and the restraints automatically begin to loosen. FIG. 38 concludes this sequence. In order to return the child seat 140 to the adult seat 115 configuration, the child seat booster 155 is lowered and the child restraint 160 are returned to the seatback compartment 400. The adult seatback 125 is then in the original position as it started in the adult seat 115.

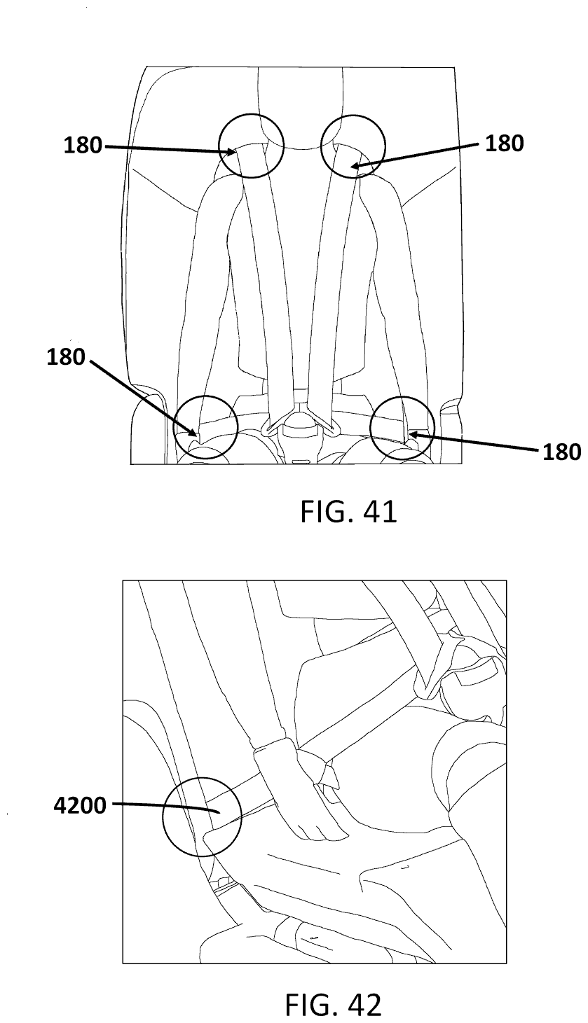

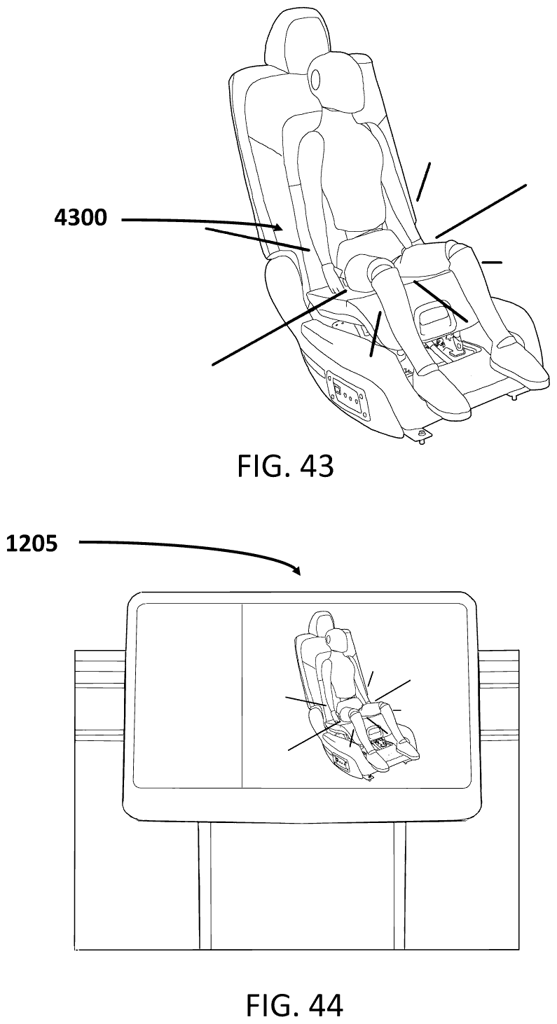

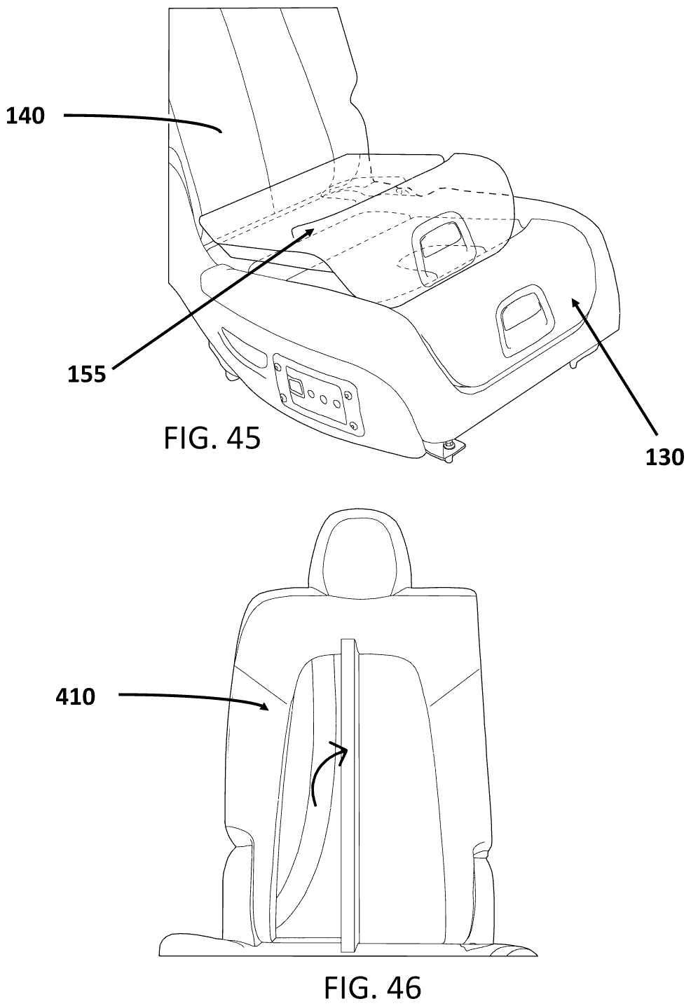

FIG. 39 depicts a five point harness 3900 of the child restraint 160. Five straps of the child restraint 160 converge at the buckle 200 in the center of the body of the child passenger to secure the child passenger. On the first installation of the integrated restraint system 100, in certain embodiments, the installer prompts the system to be ready for use to by latching and un-latching the buckle 200. FIG. 40 depicts a configuration of the integrated restraint system 100. In one embodiment, the integrated restraint system 100 is configured to include a switch or button 4000 that permits the user to switch between manual and automatic configurations of the integrated restraint system 100. In FIG. 40, the switch or button 4000 is located on the headrest handle release 2105. FIG. 40 shows a switch located between the indicator lights and the adult seat-bottom 130. FIG. 41 shows various locations of the child restraint sensor 1230. This configuration depicts five of the 1230˜2 located on the hips and shoulders of the child restraint 160. FIG. 42 depicts a retraction motor 4200. The motor location is used to automate the tightening of the child restraint 160 around the hips of the passenger. FIG. 43 shows an embodiment in which the seat assembly 110 includes an occupant detection sensor 4300 used as a occupant detection feature. The occupant detection sensor 4300 detects whether a passenger is in the seat. FIG. 44 depicts the display system 1210 system which communicates the status of the child passenger and/or the integrated restraint system 100. In this embodiment, the controller 1205 system includes a screen to communicate that there is a child remaining in the seat. This is helpful to prevent a child from being left behind in the vehicle 105. The seat assembly 110 is configured to detect all positions and stages of its configurations, including transitioning or resting in the child seat 140 configuration, as can be seen in FIG. 45. Turning to FIG. 46 depicts that the seat assembly 110 detects the status of the position of the seatback door panel 410.

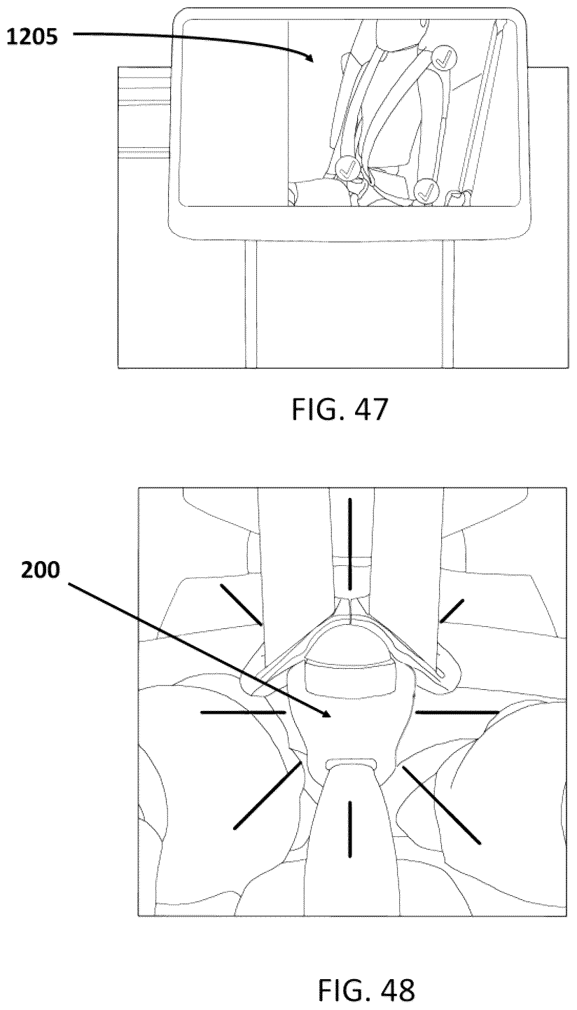

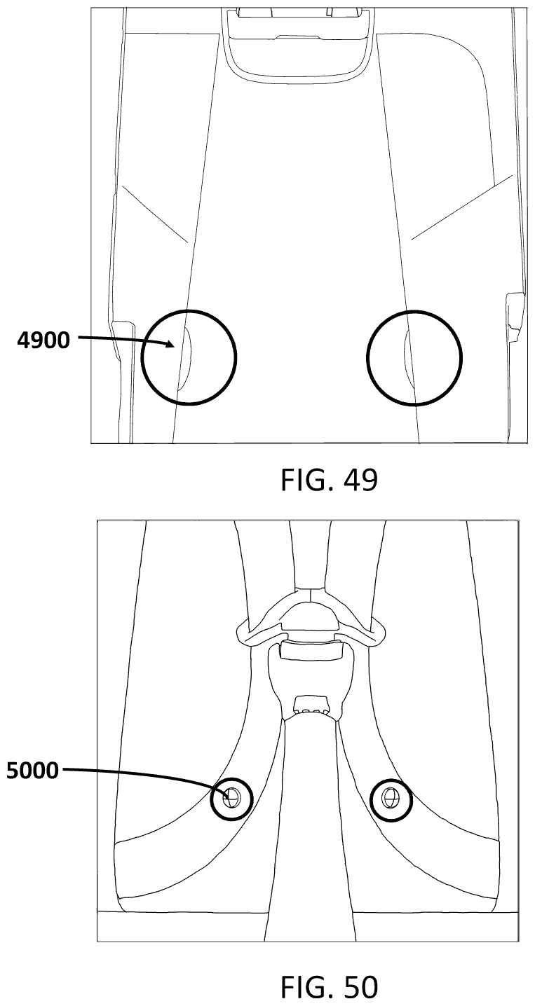

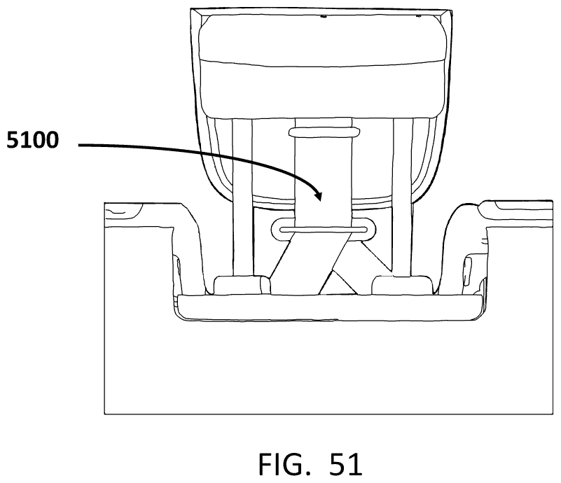

FIG. 47 shows that the seat assembly 110 detects the status of the position of the tension of the various aspects of the child restraint 160. The status of the tension of the various aspects of the child restraint 160 is displayed on the controller 1205. FIG. 48 depicts that the seat assembly 110 detects the status of the buckle 200. The status of the tension of the buckle 200 is shown on the display system 1210. FIG. 49 depicts storage configurations for the child restraint 160. The seatback compartment 400 of the adult seatback 125 in FIG. 49 is configured to include a tongue 4900 for storage in order to facilitate the child restraint 160. FIG. 50 depicts the use of a tongue stop 5000 placed on the child restraint 160 in order to catch the child restraint 160 against the tongue 4900. Configuring the tongue stops at this location helps facilitate accessibility of the child restraint 160 when the 15 is transitioning to the child seat 140 and vice versa. FIG. 51 depicts the use of a Y-belt 5100 in order to feed the child restraint 160 through the system.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Accelerometer” generally refers to a device or instrument that measures acceleration or the rate of change of velocity. In one form, the accelerometer measures proper acceleration in which the acceleration of a body relative to the instantaneous rest frame of the body. The accelerometer can include single-axis or multi-axis type accelerometers. By way of non-limiting examples, the accelerometer can include capacitive, resistive, capacitive, servo, laser, magnetic induction, optical, piezoelectric, resonance, and quantum type accelerometers, just to name a few.

“Aftermarket Product” generally refers to one or more parts and/or accessories used in repair and/or enhancement of a product already made and sold by an Original Equipment Manufacturer (OEM). For example, aftermarket products can include spare parts, accessories, and/or components for motor vehicles.

“Axis” generally refers to a straight line about which a body, object, and/or a geometric figure rotates or may be conceived to rotate.

“Ball Joint” or “Ball-and-Socket Joint” generally refers to a mechanical device that allows free rotation in two or more planes at the same time while substantially preventing translation motion in any direction. The ball joint for example includes a spherical knob or knoblike part that fits into a cavity or socket of another part. In one version, the ball joint includes a bearing stud and socket attached in a casing.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Concave” generally refers to a surface that curves inward, or is thinner in the middle than on the edges. For example, the surface of a griddle may be concave if the surface slopes downward from the outer edge towards the middle section. Concavity in a surface generally creates a low spot in the center that liquids will flow towards.

“Contact” generally refers to a condition and/or state where at least two objects are physically touching. For example, contact requires at least one location where objects are directly or indirectly touching, with or without any other member(s) material in between.

“Controller” generally refers to a device, using mechanical, hydraulic, pneumatic electronic techniques, and/or a microprocessor or computer, which monitors and physically alters the operating conditions of a given dynamical system. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller, or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry, and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Couple” or “Coupled” generally refers to an indirect and/or direct connection between the identified elements, components, and/or objects. Often the manner of the coupling will be related specifically to the manner in which the two coupled elements interact.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour. Data may be organized and represented in a structured format. Examples include a tabular representation using rows and columns, a tree representation with a set of nodes considered to have a parent-children relationship, or a graph representation as a set of connected nodes to name a few. The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Door Panel” generally refers to a device to open a compartment. The door panel can include different configurations such as a drawbridge style, a bomb bay, butterfly style, hinged door, pocket door, bifold door, roller door, sliding door, Velcro, zipper, winged door, mesh, scissor doors, canopy door, dihedral, louvered door, a molded panel door, barn door, double barn door, or pocket door.

“Electric Motor” generally refers to an electrical machine that converts electrical energy into mechanical energy. Normally, but not always, electric motors operate through the interaction between one or more magnetic fields in the motor and winding currents to generate force in the form of rotation. Electric motors can be powered by direct current (DC) sources, such as from batteries, motor vehicles, and/or rectifiers, or by alternating current (AC) sources, such as a power grid, inverters, and/or electrical generators. An electric generator can (but not always) be mechanically identical to an electric motor, but operates in the reverse direction, accepting mechanical energy and converting the mechanical energy into electrical energy.

“Electrically Connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Five-Point Harness” generally refers to a restraint system that includes five straps or web portions that are mounted to a seat. Two of the straps are typically located to secure at the shoulders of an occupant of the seat, and another two of the straps are typically located proximal the hips of the occupant when seated. One of the straps is located at the crotch of the occupant when seated in the seat, and this strap typically includes a releasable buckle or other similar mechanism that releasable secures the five straps together so as to secure the occupant in the seat. The straps can be tightened or loosened depending on the size of the occupant and/or whether the occupant is being secured or removed from the seat. Five-point harnesses can be for example integrated into race car seats or child safety seats.

“Handle” generally refers to a part that is designed especially to be grasped by a human hand. In other words, a handle is a part by which an object, such as a tool or device, is held, carried, and/or controlled by a human hand. A handle typically has sufficient strength to support the object. For tools, the handle typically has sufficient strength to transmit any force from the handle to perform the designed functionality for the tool. The handle usually has a sufficient length to accommodate a single hand or multiple hands to grip and reliably exert force through the handle. Similarly, the handle commonly has a sufficiently small circumference or exterior size to permit single hand or multiple hands to reliably grip the handle. Other ergonomic factors, such friction, coating, grip, and injury prevention features, can be incorporated into the handle. By way of non-limiting examples, the handles can include broom handles, shovel handles, pull handles, or twist handles, to name just a few.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Headrest” or “Head Restraint” generally refers to a structure attached or otherwise integrated into the top of a seat to limit the rearward movement of the head of the seat occupant, relative to the torso, in a collision. For instance, the headrest is designed to prevent or mitigate whiplash or other injury to the cervical vertebrae. The headrest can include a fixed headrest or an adjustable headrest. The adjustable headrest is capable of being positioned to fit the morphology of the seated occupant. The adjustable headrest can be adjusted manually and/or automatically. Another type of headrest includes an active head restraint designed to automatically improve head restraint position and/or geometry for the seat occupant during a collision.

“Hinge” generally refers to a mechanical bearing or other device that connects at least two solid objects so as to allow only an angle of rotation between the objects. In one example, the objects connected by the hinge can rotate relative to each other about a fixed axis of rotation such that all other relative translations and/or rotations being are prevented to provide one degree of freedom. In other examples, the hinge can provide multiple degrees of freedom. For instance, a living hinge, which is made of flexible material like plastic, can provide multiple axes of rotational freedom. In one form, the hinge includes a leaf with a knuckle that receives a pin. Some examples of hinge types include spring hinges, barrel hinges, pivot hinges, butt-mortise hinges, case hinges, piano hinges, concealed hinges, butterfly hinges, flag hinges, strap hinges, H-hinges, counter-flap hinges, self-closing hinges, friction hinges, double action hinges, and crank hinges, to name just a few.

“Input Device” generally refers to any device coupled to a computer that is configured to receive input and deliver the input to a processor, memory, or other part of the computer. Such input devices can include keyboards, mice, trackballs, and touch sensitive pointing devices such as touchpads or touchscreens. Input devices also include any sensor or sensor array for detecting environmental conditions such as temperature, light, noise, vibration, humidity, and the like.

“Input/Output (I/O) Device” generally refers to any device or collection of devices coupled to a computing device that is configured to receive input and deliver the input to a processor, memory, or other part of the computing device and/or is controlled by the computing device to produce an output. The I/O device can include physically separate input and output devices, or the input and output devices can be combined together to form a single physical unit. Such input devices of the I/O device can include keyboards, mice, trackballs, and touch sensitive pointing devices such as touchpads or touchscreens. Input devices also include any sensor or sensor array for detecting environmental conditions such as temperature, light, noise, vibration, humidity, and the like. Examples of output devices for the I/O device include, but are not limited to, screens or monitors displaying graphical output, a projecting device projecting a two-dimensional or three-dimensional image, or any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Isofix” or “ISOFIX” generally refers to an international standard for attachment points for child safety seats in passenger cars and other vehicles and/or attachment point or anchoring systems that satisfy the standard. More specifically, Isofix refers International Organization for Standardization (ISO) standard ISO 13216, which specifies the anchoring system for Group 1 child safety seats. This standard defines standard attachment points to be manufactured into cars, enabling compliant child safety seats to be quickly and safely secured. Isofix acts as an alternative to securing the seat with seat belts. In one form, child safety seats are secured with a single attachment at the top (e.g., top tether) and two attachments at the base of each side of the seat. The Isofix standard can be identified by other regional names. In the United States for example, the standard is commonly referred to as a LATCH (“Lower Anchors and Tethers for Children”) system.

“Latch Plate” generally refers to a part of a vehicle belt assembly that releasably connects to a buckle and through which the webbing is threaded or otherwise secured. Typically, but not always, the latch plate is in at least part made of metal and/or plastic. The latch plate includes one or more tongues that are inserted into the buckle. Each tongue can include a notch or other opening that is used to secure the latch plate to the buckle. By way of non-limiting examples, the latch plates can include free-sliding latch plates, cinching latch plates, locking latch plates, and switchable latch plates, to name just a few examples.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Longitudinal” generally refers to the length or lengthwise dimension of an object, rather than across.

“Magnet” generally refers to a material or object that produces a magnetic field external to itself. Types of magnets include permanent magnets and electromagnets. By way of non-limiting examples, magnets in certain circumstances are able to attract (or repel) objects such as those made of iron or steel.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, a hydraulic motor, a steam engine, a pneumatic piston, a hydraulic piston, and/or an internal combustion engine.

“Original Equipment Manufacturer” or “OEM” generally refers to an organization that makes finished devices from component parts bought from other organizations that are usually sold under their own brand in a consumer or commercial market.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Push Button Adjuster” generally refers to a webbing, belt, or strap adjustment mechanism that releases the hold of the mechanism on the webbing for the purpose of releasing tension and/or lengthening the webbing when a button is depressed. Typically, but not always, the pushbutton adjuster does not inhibit the webbing from being shortened when the free end of the webbing is pulled.

“Seat” generally refers to a type of support structure or a place constructed for the purpose of allowing a human and/or other animal to sit. Some examples of seats include chairs, stools, benches, saddles, and sofas to name just a few. Typically, but not always, the seat can further include a backrest, armrest, and a headrest as well as other features.

“Seat Belt”, “Safety Belt”, “Vehicle Belt”, or “Belt” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Slide Adjuster” generally refers to hardware used to lock webbing at a fixed length using a single plate or at least a pair of plates with slots through which the webbing is threaded in a prescribed manner. By way of non-limiting examples, the slide adjuster may use one slide with three slots or two slides with two slots each. Typically, but not always, the webbing must be detached and the webbing loops manually loosened to either shorten or lengthen the webbing.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Tilt-Lock Adjuster” generally refers to a webbing or strap adjustment mechanism that releases the hold of the mechanism on the webbing for the purpose of releasing tension and/or lengthening the webbing when the mechanism is lifted and/or held at an angle that is generally transverse to the general longitudinal direction of the webbing. Typically, but not always, the tilt-lock adjuster does not inhibit the overall length of the webbing from being shortened when the free end of the webbing is pulled.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Web” or “Webbing” generally refers to a strap made of a network of thread, strings, cords, wires, and/or other materials designed to restrain or otherwise hold a person or other object steady such as in a boat, vehicle, aircraft, and/or spacecraft. By way of non-limiting examples, the web can be incorporated into a seat belt, a child booster seat, and/or a car seat.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 integrated restraint system
105 vehicle
110 seat assembly
115 adult seat
120 adult seat headrest
125 adult seatback
130 adult seat-bottom
135 adult restraint
140 child seat
145 child seat headrest
150 child seat back
155 child seat booster
160 child restraint
162 harness
163 belts
165 stowable compartment
180 sensor
200 buckle
205 booster handle release lever
210 seat assembly attachment mechanism
215 grooved receiving mechanism
220 headrest side-support structure
300 seat adjustment support structure
305 linkage assembly
310 seat bottom compartment
400 seatback compartment
405 recessed child restraint
410 seatback door panel
415 seatback activation handle
505 opening
505 joint lever
610 concave groove
615 convex groove
620 cross beam
700 internal release mechanism
705 clasp
710 release hammer
715 pneumatic arm
720 extendable arm portion
725 rotatable connection clasp
730 footrest
800 tightening mechanism
905 restraint tightening mechanism
1200 automated system
1205 controller
1210 display system
1215 headrest sensor
1220 seatback sensor
1225 booster sensor
1230 child restraint sensor
1235 display system sensor
1400 adult buckle
1500 automation mechanism
1505 motor
1510 wiring
1515 slack removal mechanism
1900 flowchart
1905 stage
1910 stage
1915 stage
1920 stage
1925 stage
1930 stage
1935 stage
1940 stage
1945 stage
1950 stage
1955 stage
1960 stage
1965 stage
2000 flowchart
2005 stage
2005 stage
2010 stage
2015 stage
2020 stage
2025 stage
2030 stage
2035 stage
2105 headrest handle release
3000 winged door panel
3900 five point harness
4000 switch or button
4200 retraction motor
4300 occupant detection sensor
4900 tongue
5000 tongue stop
5100 Y-belt

What is claimed is:

1. A vehicle safety system, comprising:
a vehicle seat; and
a child restraint system integrated with the vehicle seat.

2. The vehicle safety system of claim 1, wherein the child restraint system includes an occupant detection system.

3. The vehicle safety system of claim 1, wherein the child restraint system includes one or more position sensors configured to determine seat bottom position.

4. The vehicle safety system of claim 1, wherein:
the child restraint includes a harness system; and
the harness system is stored behind a door panel in a seat back of the vehicle seat.

5. The vehicle safety system of claim 4, wherein:
the harness system includes one or more load sensors; and
the load sensors work in combination with a motor to automatically adjust harness fit.

6. The vehicle safety system of claim 1, wherein the child restraint system is configured to automatically deploy.

7. The vehicle safety system of claim 1, wherein the child restraint system is configured to automatically stow.

8. The vehicle safety system of claim 1, further comprising:
an input/output (I/O) device configured to facilitate interactions with the child restraint system.

9. The vehicle safety system of claim 1, wherein:
the vehicle seat includes a seat bottom and a seat back;
the seat back includes a door panel configured to move; and
the door panel includes a set of bomb bay doors.

10. The vehicle safety system of claim 9, wherein:
the vehicle seat includes a seat bottom and a seat back;
the seat back includes a door panel configured to move; and
the door panel includes a drawbridge type door.

11. A method, comprising:
deploying a booster seat from a stowed position to a boosted position;
loosening a harness;
wherein the harness includes one or more belts;
wherein the harness includes a buckle; and
buckling an occupant into the harness of the booster seat when in the boosted position by latching the buckle.

12. The method of claim 11, further comprising:
opening one or more door panels in a seat back to reveal at least part of the harness.

13. The method of claim 12, wherein:
the door panels include a drawbridge type panel; and
the deploying the booster seat includes folding the drawbridge type panel away from the seat back to form the booster seat.

14. The method of claim 12, wherein the door panels have a bomb bay door type configuration.

15. The method of claim 12, further comprising:
detecting state of the door panels with one or more door sensors.

16. The method of claim 12, further comprising:
storing the harness; and
wherein the storing includes stowing the belts of the harness behind the door panels.

17. The method of claim 11, wherein the deploying the booster seat includes actuating a release lever on the booster seat to release the booster seat.

18. The method of claim 11, wherein the deploying the booster seat includes exposing a foot rest when in the boosted position.

19. The method of claim 11, further comprising:
actuating a headrest lever located on a headrest to allow slackening of the harness.

20. The method of claim 19, further comprising:
raising the headrest while actuating the headrest lever.

21. The method of claim 11, further comprising:
unlatching the buckle to release the occupant from the harness; and
detecting the unlatching of the buckle with a controller via a buckle sensor.

22. The method of claim 21, further comprising:
stowing the booster seat by moving the booster seat from the boosted position to the stowed position; and
detecting the booster seat is in the stowed position with the controller via a booster seat sensor.

23. The method of claim 22, further comprising:
retracting the belts of the harness with a motor in response to the detecting the unlatching of the buckle and the detecting the booster seat is in the stowed position.

24. The method of claim 22, wherein the stowing the booster seat includes folding the booster seat into a seatback.

25. The method of claim 11, further comprising:
providing an indicator that an occupant is secured in a proper manner in the harness.

26. The method of claim 11, further comprising:
detecting the booster seat at the boosted position with a controller via a booster seat sensor;
loosening one or more belts of a harness in response to the detecting the booster seat at the boosted position; and
wherein the loosening includes activating a motor with the controller to relieve tension from the belts.

27. The method of claim 26, further comprising:
detecting buckling of the buckle of the harness with the controller via a buckle sensor;
tightening the belts of the harness until proper tension is reached; and
wherein the tightening occurs in response to the detecting the buckling of the buckle.

28. The method of claim 27, further comprising:
delaying the tightening for a delay period after the detecting of the buckling of the buckle.

29. The method of claim 28, wherein the delay period is at least 2 seconds.

30. The method of claim 11, further comprising:
tightening the belts of the harness;
wherein the tightening includes activating a motor with a controller to apply tension to the belts;
sensing tension of the belts with a belt tension sensor; and
applying tension to the belts until at least a belt tension limit is sensed with the belt tension sensor.

31. The method of claim 30, further comprising:
calibrating the controller by latching and unlatching the buckle.

32. The method of claim 11, further comprising:
switching between an automatic tensioning mode and a manual tensioning mode of the harness when a switch is actuated.

33. The method of claim 32, further comprising:
changing to the automatic tensioning mode by unlatching the buckle.
